(19) United States
(12) Patent Application Publication
(10) Pub. No.: US 2018/0351655 A1
(43) Pub. Date: Dec. 6, 2018

(54) OUTPUT APPARATUS, METHOD FOR CONTROLLING OUTPUT OF ACOUSTIC WAVE, AND INFORMATION PROVIDING SYSTEM

(71) Applicants: Takaya Ochiai, Kanagawa (JP); Tsutomu Kawase, Kanagawa (JP); Takashi Saito, Kanagawa (JP); Shingo Matsushita, Tokyo (JP); Akihiro Asai, Kanagawa (JP)

(72) Inventors: Takaya Ochiai, Kanagawa (JP); Tsutomu Kawase, Kanagawa (JP); Takashi Saito, Kanagawa (JP); Shingo Matsushita, Tokyo (JP); Akihiro Asai, Kanagawa (JP)

(21) Appl. No.: 15/989,239

(22) Filed: May 25, 2018

(30) Foreign Application Priority Data
May 31, 2017 (JP) 2017-108695

(51) Int. Cl. H04B 11/00; H04R 1/22

(52) U.S. Cl. CPC H04B 11/00; H04R 1/22

(57) ABSTRACT

An output apparatus outputs an acoustic wave set with a specific frequency indicating identification information to a terminal apparatus that is to acquire the identification information from the acoustic wave. The output apparatus includes circuitry. The circuitry adjusts the specific frequency of the acoustic wave to another frequency by applying a predetermined frequency to the specific frequency, depending on a moving direction of a terminal apparatus that is to be notified of the identification information. The circuitry generates the acoustic wave of the another frequency. The circuitry outputs the generated acoustic wave of the another frequency.

### CROSS-REFERENCE TO RELATED APPLICATION

This patent application is based on and claims priority pursuant to 35 U.S.C. § 119(a) to Japanese Patent Application No. 2017-108695, filed on May 31, 2017, in the Japan Patent Office, the entire disclosure of which is hereby incorporated by reference herein.

### BACKGROUND

### Technical Field

The present disclosure relates to an output apparatus, a method for controlling an output of an acoustic wave, and an information providing system.

### Description of the Related Art

An information providing system is known that provides a terminal apparatus with position information or the like using acoustic waves. The terminal apparatus acquires its position based on the provided position information.

Further, an ultrasonic communication system is known that performs ultrasonic communication between a beacon that is provided in a specific area and transmits ultrasonic waves and a mobile terminal that exists in the specific area.

The information providing system as described above that provides information using acoustic waves may provide information terminals that are present in a specific area with not only the position information but also various information such as store information, event information, and transportation service information.

A plurality of users, each carrying the information terminal with him- or herself, are present within the specific area for various purposes. For example, there are a person heading from a station to a workplace, a person heading to a station to take a train, a person entering a store, a person leaving a store, and a person standing and operating his or her information terminal.

However, in the conventional information providing system, the same information is uniformly provided to the information terminals that are present in the specific area.

### SUMMARY

An output apparatus outputs an acoustic wave set with a specific frequency indicating identification information to a terminal apparatus that is to acquire the identification information from the acoustic wave. The output apparatus includes circuitry. The circuitry adjusts the specific frequency of the acoustic wave to another frequency by applying a predetermined frequency to the specific frequency, depending on a moving direction of a terminal apparatus that is to be notified of the identification information. The circuitry generates the acoustic wave of the another frequency. The circuitry outputs the generated acoustic wave of the another frequency.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 a block diagram illustrating an example of a configuration of an information providing system according to an embodiment of the present disclosure;

FIG. 2 is a diagram illustrating an example of a plurality of areas, according to an embodiment of the present disclosure;

FIG. 3 is an illustration for explaining an example of how an acoustic wave is output, according to an embodiment of the present disclosure;

FIGS. 4A to 4D are illustrations for explaining an example of how an acoustic wave is output, according to an embodiment of the present disclosure;

FIGS. 5A to 5C are diagrams for explaining an example of how to change a frequency, according to an embodiment of the present disclosure;

FIG. 6 is an example external view of an output apparatus, according to an embodiment of the present disclosure;

FIG. 7 is a block diagram illustrating an example of a hardware configuration of the output apparatus, according to an embodiment of the present disclosure;

FIG. 8 is a block diagram illustrating an example hardware configuration of a computer, according to an embodiment of the present disclosure;

FIG. 9 is a block diagram illustrating an example of a functional configuration of the output apparatus, according to an embodiment of the present disclosure;

FIG. 10 a block diagram illustrating an example of a functional configuration of the information providing system, according to an embodiment of the present disclosure;

FIGS. 11A and 11B are diagrams illustrating an example of information managed by the information providing system, according to an embodiment of the present disclosure;

FIG. 12 is a flowchart illustrating an example of a basic operation performed by the output apparatus, according to an embodiment of the present disclosure;

FIGS. 13A and 13B are each a flowchart illustrating an example of operation performed by the output apparatus, according to a first embodiment of the present disclosure;

FIGS. 14A and 14B are each a flowchart illustrating an example of operation performed by the output apparatus, according to the first embodiment of the present disclosure;

FIG. 15 is a flowchart illustrating an example of an operation performed by an information terminal, according to the first embodiment of the present disclosure;

FIGS. 16A and 16B are each a flowchart illustrating an example of operation performed by the output apparatus, according to a second embodiment of the present disclosure;

FIG. 17 is a flowchart illustrating an example of operation performed by the output apparatus, according to a third embodiment of the present disclosure;

FIG. 18 is an illustration for describing a concept of an acoustic wave output process according to a fourth embodiment of the present disclosure;

FIG. 19 is a flowchart illustrating an example of operation performed by the output apparatus, according to the fourth embodiment of the present disclosure;

FIG. 20 is a flowchart illustrating an example of operation performed by the output apparatus, according to a fifth embodiment of the present disclosure;

FIG. 21 is a flowchart illustrating an example of operation performed by the output apparatus, according to a sixth embodiment of the present disclosure;

FIG. 22 is a flowchart illustrating an example of operation performed by the output apparatus, according to a seventh embodiment of the present disclosure, and

FIG. 23 is a flowchart illustrating an example of operation performed by the output apparatus, according to an eighth embodiment of the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a description is given of several embodiments of the present disclosure with reference drawings.

System Configuration:

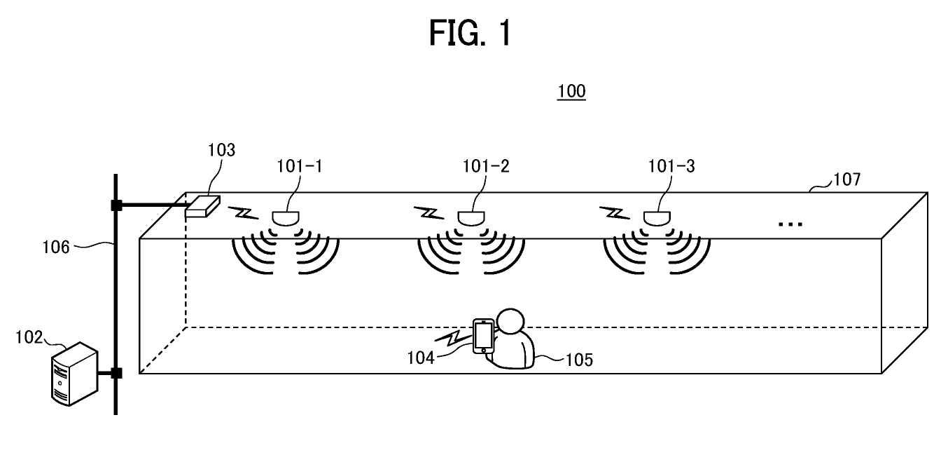

FIG. 1 a block diagram illustrating an example of a configuration of an information providing system according to an embodiment of the present disclosure. The information providing system 100 includes, for example, output apparatuses 101-1, 101-2, 101-3, . . . , a management server 102, a gateway 103, and an information terminal 104. Any arbitrary one or more of the output apparatuses 101-1, 101-2, and 101-3 is referred to hereinafter as the “output apparatus 101”, in order to simplify the description. In addition, the number of the output apparatus 101, the gateway 103, and the information terminal 104 is not limited to that illustrated in FIG. 1.

The output apparatuses 101-1, 101-2 and 101-3 are installed at different positions on a ceiling of a building 107, for example. The output apparatus 101 outputs, to a specific area, an acoustic wave set with a specific frequency, such as an acoustic wave representing identification information (hereinafter referred to as an “acoustic wave ID”) using the specific frequency. In addition, the plurality of output apparatuses 101 configure a wireless network with the gateway 103. Accordingly, the plurality of output apparatuses 101 are communicable with the management server 102 via the gateway 103.

In an example of FIG. 1, the output apparatus 101-1 includes two speakers. A first speaker of the two speaker outputs an acoustic wave including a first sound ID to a first area. A second speaker of the two speakers outputs an acoustic wave including a second acoustic wave ID to a second area different from the first area. The output apparatus 101 may include any other suitable number of speakers, provided that the output apparatus 101 includes at least one speaker.

Preferably, the acoustic wave including the first acoustic wave ID and the acoustic wave including the second wave ID output from the output apparatus 101 are in an inaudible sound range, such as 16 kHz to 20 kHz, which is higher than a given frequency such as 16 kHz. Since an acoustic wave whose frequency is equal to or higher than 16 kHz can hardly be heard by humans, an acoustic wave in the inaudible sound range is suitable for transmitting acoustic wave ID to a specific area.

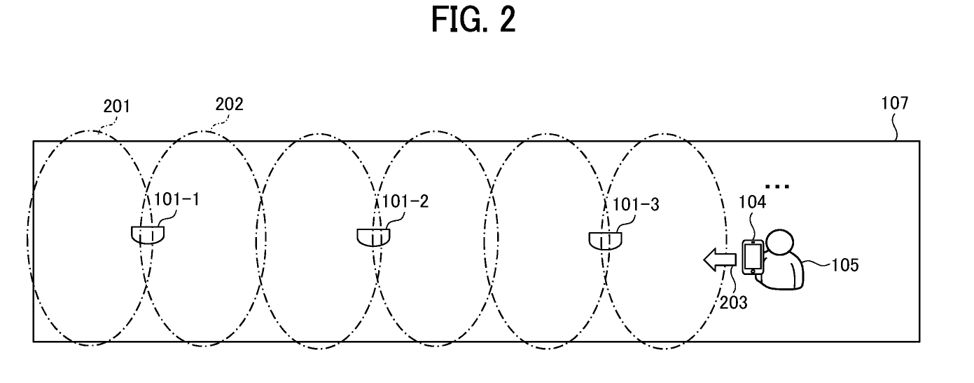

FIG. 2 is a diagram illustrating an example of a plurality of areas, according to an embodiment of the present disclosure. FIG. 2 illustrates the building 107 illustrated in FIG. 1 viewed from top. In FIG. 2, the first speaker of the output apparatus 101-1 outputs the acoustic wave including the first acoustic wave ID to a first area 201. In addition, the second speaker outputs an acoustic wave including the second acoustic wave ID to a second area 202.

Further, as illustrated in FIG. 2, the other output apparatuses 101-2 and 101-3 also output the acoustic wave including the first sound ID and the acoustic wave including the second sound ID in substantially the same manner as the output apparatus 101-1. In one example, the first acoustic wave ID and the second acoustic wave ID may be the same. In another example, the first acoustic wave ID and the second acoustic wave ID are different from each other.

In addition, each of the first acoustic wave ID and the second acoustic wave ID may be a combination of a plurality of acoustic wave IDs. For example, the output apparatus 101 outputs, as the first acoustic wave, acoustic waves including acoustic wave IDs that are different from each other, by switching the acoustic waves from one to another successively in units of time, such as every 100 ms.

Referring again to FIG. 1, the description of the system configuration of the information providing system 100 is continued.

The management server 102 is, for example, a system including one information processing apparatus or a plurality of information processing apparatuses, connected to a network 106 such as the Internet or a local area network (LAN). Examples of the information processing apparatus includes a personal computer (PC).

The management server 102 is an information processing apparatus(es) that is communicable with the plurality of output apparatuses 101 via the network 106 and the gateway 103, and manages acoustic waves output from the plurality of output apparatuses 101 and acoustic wave IDs included in the acoustic waves.

Further, the management server 102 is an example of an information providing apparatus, which provides the information terminal 104 with information (hereinafter referred to as “provided information”) corresponding to the acoustic wave ID in response to receiving, from the information terminal 104, an information acquisition request including the acoustic wave ID acquired by the information terminal 104.

The gateway 103 is connected to the management server 102 via the network 106, and forms a wireless network with the plurality of output apparatuses 101. The gateway 103 transfers (relays) data between a plurality of output apparatuses 101 connected to the wireless network provided by the gateway 103 and the management server 102. In addition, the gateway 103 converts communication protocols as needed.

The information terminal (terminal apparatus) 104 is an information terminal that is owned by a user 105 and connects to the network 106 using wireless communication to communicate with the management server 102. Examples of the information terminal 104 include a smartphone, a mobile phone, a tablet terminal. Further, the information terminal 104 executes an application program for the information terminal 104 corresponding to the information providing system 100. Hereinafter, the application program is referred to as an “application” in order to simplify the description. When installed in the information terminal 104, the application for the information terminal 104 generates terminal identification information (hereinafter referred to as “application ID”) for identifying the information terminal 104. By executing the application for the information terminal 104, the information terminal 104 acquires an acoustic wave outputted by the output apparatus 101 using a built-in microphone or the like. Further, the information terminal 104 extracts the acoustic wave ID included in the acquired acoustic wave.

After extracting the acoustic wave ID included in the acoustic wave output from the output apparatus 101, the information terminal 104 transmits request information including the extracted acoustic wave ID of the output apparatus 101 and the application ID of the information terminal 104 to the management server 102. Further, the information terminal 104 acquires the provided information that corresponds to the acoustic wave ID and is transmitted from the management server 102, and display a content of the provided information.

The application ID is an example of terminal identification information for identifying the information terminal 104 that transmits the request information. By using the application ID, the information providing system 100 can identify the information terminal 104 without personal information such as a telephone number or a mail address. However, the application ID is just one example of the terminal identification information. In another example, the information terminal 104 may use individual identification information of the information terminal, account information of a user, etc. in place of the application ID.

Doppler Effect:

For example, in FIG. 2, when the user 105 carrying the information terminal 104 moves in a direction of an arrow 203, i.e., toward the output apparatus 101-3, the frequency of the acoustic wave acquired by the information terminal 104 is higher than the frequency of the acoustic wave output from the output apparatus 101-3. By contrast, when the user 105 moves in a direction away from the output apparatus 101-3, the frequency of the acoustic wave acquired by the information terminal 104 is lower than the frequency of the acoustic wave output from the output apparatus 101-3.

This phenomenon is known as the Doppler effect. For example, the Doppler effect is expressed by the following Equation (1):

$$Equation ( 1 ) \text{:}$$

$$f = \frac{V - {v}_{0}}{V} f 0 \qquad ( 1 )$$

In Equation (1), a direction away from the output apparatus 101 is assumed as positive, and Vo represents the moving speed of the information terminal 104, f0 represents the frequency of the acoustic wave output from the output apparatus 101, f represents the frequency of the acoustic wave acquired by the information terminal 104, and v represents the sound velocity.

Due to this Doppler effect, the frequency f of the acoustic wave acquired by the information terminal 104 is different from the frequency f0 of the acoustic wave output from the output apparatus 101. Accordingly, it is possible that the information terminal 104 fails to correctly acquire the acoustic wave ID included in the acoustic wave, depending on the moving speed of the information terminal 104.

Output of Acoustic Wave:

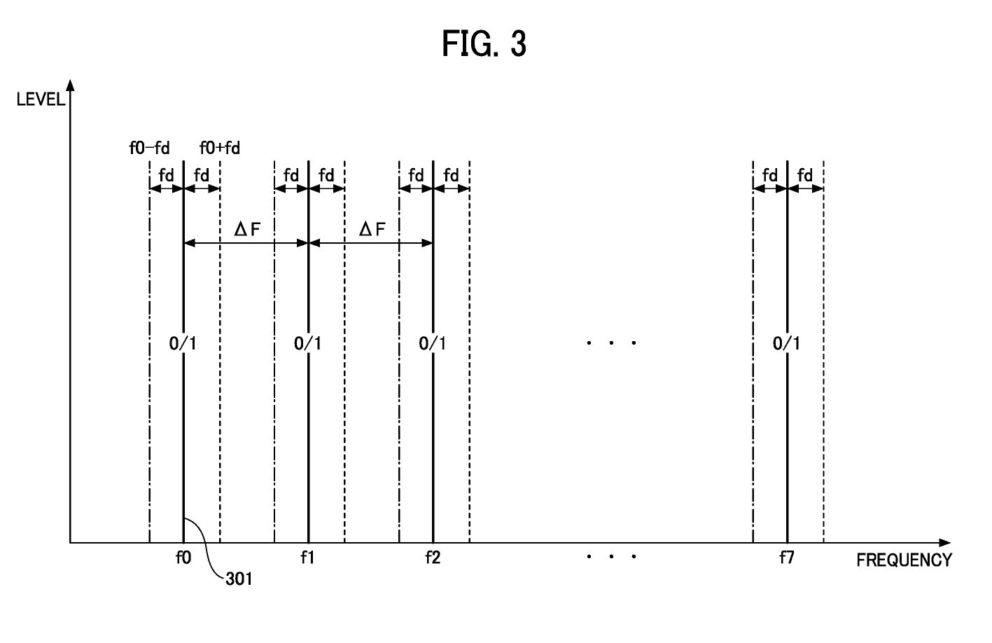

FIG. 3 is an illustration for explaining an example how an acoustic wave is output, according to an embodiment of the present disclosure. The output apparatus 101 according to the present embodiment generates an acoustic wave representing identification information using specific frequencies, and outputs the generated acoustic wave.

FIG. 3 illustrates an example of 8-bit identification information defined by eight frequencies f0, f1, and f2 to f7, in which each frequency corresponds to each one of eight bits. More specifically, the frequency f0 corresponds to a first bit, the frequency f1 corresponds to a second bit, the frequency f2 corresponds to a third bit, . . . , and the frequency f7 corresponds to an eighth bit. Each bit takes a digital value of “1” when an acoustic wave of the corresponding specific frequency is output, and takes a digital value of “0” when the acoustic wave of the corresponding specific frequency is not output. The number of bits of the identification information is not limited to “8,”, but any other number of bits can be used. A frequency in the inaudible sound range as described above is used as the frequency f0, such as 18.0 kHz. The frequencies f0 to f7 are separated by a specific interval ΔF, such as 120 Hz.

Further, the output apparatus 101 shifts the frequency of each of the frequencies f0 to f7 by a predetermined frequency fd such as 10 Hz, based on the moving direction of the information terminal 104 to be notified of the acoustic wave ID.

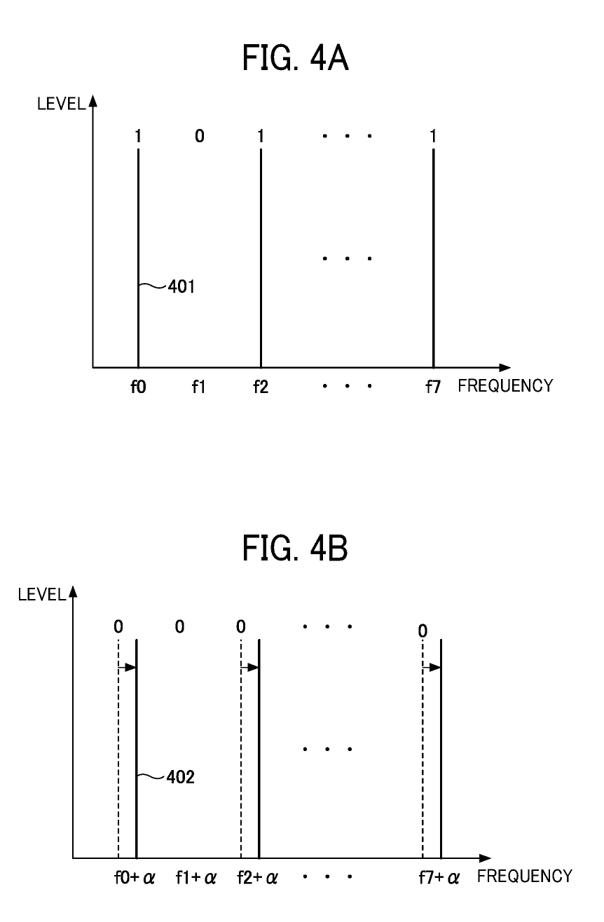

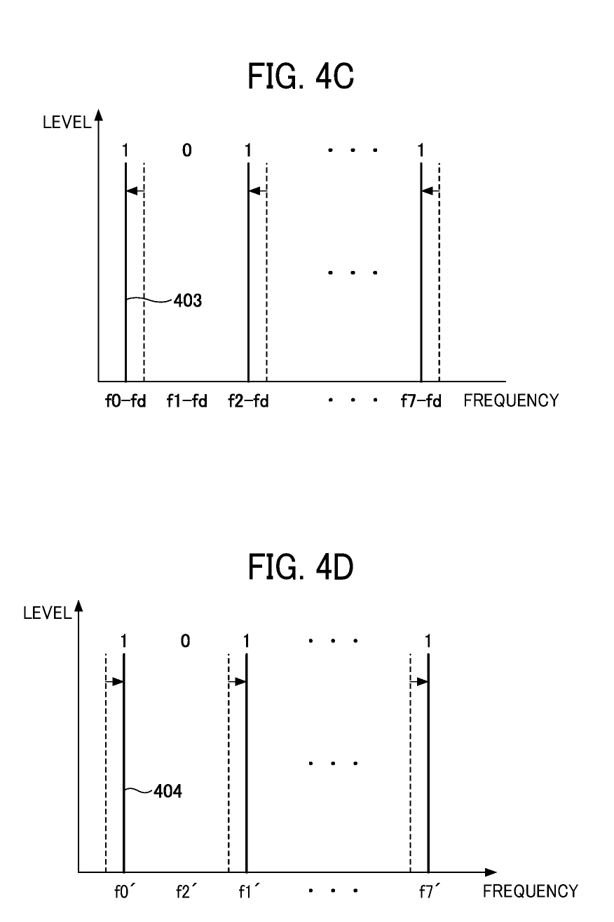

FIG. 4A illustrates an example of an acoustic wave 401 that the output apparatus 101 outputs using the frequencies f0 to f7. In an example of FIG. 4A, since the acoustic wave of the frequency f0 is output, the first bit is “1”. Further, since the acoustic wave of the frequency f1 is not output, the second bit is “0”.

FIG. 4B is an illustration for explaining an example case in which the information terminal 104 moving toward the output apparatus 101 acquires the acoustic wave output from the output apparatus. As illustrated in FIG. 4B, due to the above-described Doppler effect, frequencies of an acoustic wave 402 acquired by the information terminal 104 is higher than frequencies of the acoustic wave 401 output by the output apparatus 101.

In this case, since the information terminal 104 determines whether the acoustic waves at the frequencies f0 to f7 are present, the information terminal 104 may determine that each of the first to eighth bit is “0”, as indicated by broken lines in FIG. 4B.

To address such problem, in the related art, if the information terminal 104 receives an acoustic wave having a frequency within a predetermined range such as −100 Hz to +100 Hz from each of the frequencies f0 to f7, the information terminal 104 determines that the corresponding bit is “1”.

In the present embodiment, taking advantage of the phenomenon that the information terminal 104 cannot acquire the acoustic wave ID included in the acoustic wave due to the Doppler effect, specific information is notified to the information terminal 104 depending on a movement status such as a moving direction of the information terminal 104. For example, when to notify acoustic wave to the information terminal 104 moving toward the output apparatus 101, frequencies of an acoustic wave 403 are set to “f0-fd” to “f7-fd,” as indicated by bold lines in FIG. 4C, which are shifted in an arrow direction. In other words, the frequencies of the acoustic wave 403 (bold lines in FIG. 4C) is set lower than the frequencies f0 to f7 of the acoustic wave 401 (dot lines in FIG. 4C) for by a predetermined frequency fd.

FIG. 4D is an illustration for explaining an example case in which the information terminal 104 moving toward the output apparatus 101 acquires the acoustic wave illustrated in FIG. 4C. In this case, the frequencies f0′ to f7′ of an acoustic wave 404 acquired by the information terminal 104 are close to the predetermined frequencies f0 to f7 due to the Doppler effect. Accordingly, the information terminal 104 can recognize the values of the first to the eighth bits.

The predetermined frequency fd may be calculated in advance using the Equation (1) based on an average walking speed. In another example, an optimum value obtained in advance by experiment may be set as the frequency fd.

It should be noted that the information terminal 104 moving in a direction away from the output apparatus 101 cannot acquire the acoustic wave ID included in the acoustic wave having frequencies obtained by lowering the frequencies f0 to f7 by the frequency fd as illustrated in FIG. 4C. Thus, according to the present embodiment, the output apparatus 101 can provide different information selectively to information terminals 104 that move in different directions, by changing the frequencies f0 to f7 depending on the moving direction of the information terminal 104.

For example, when providing the acoustic wave ID to the information terminal 104 moving in a direction away from the output apparatus 101, the output apparatus 101 changes the frequencies f0 to f7 to frequencies higher than frequencies f0 to f7 by the predetermined frequency fd.

Changing Frequency:

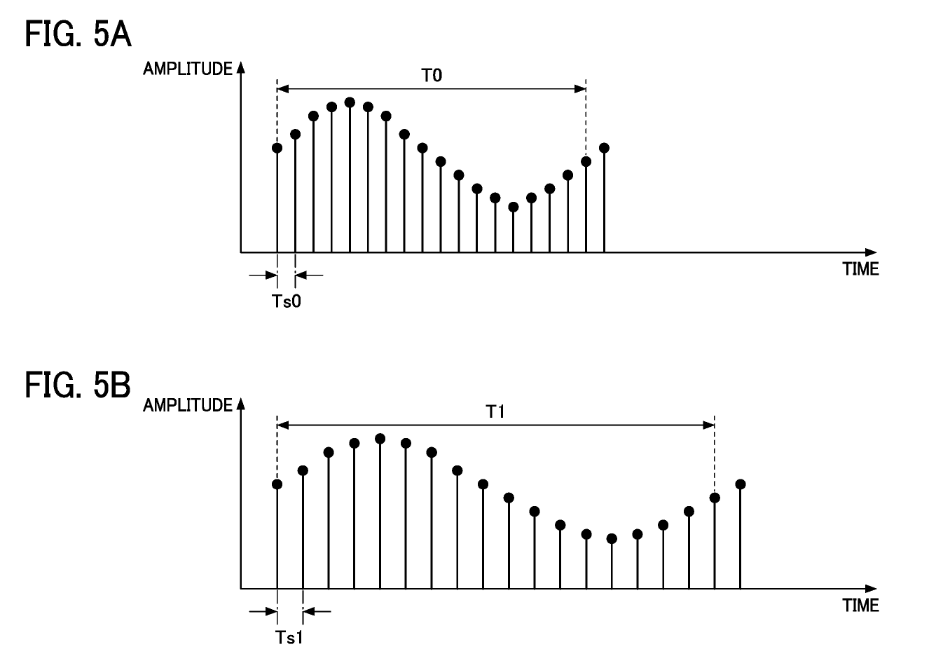

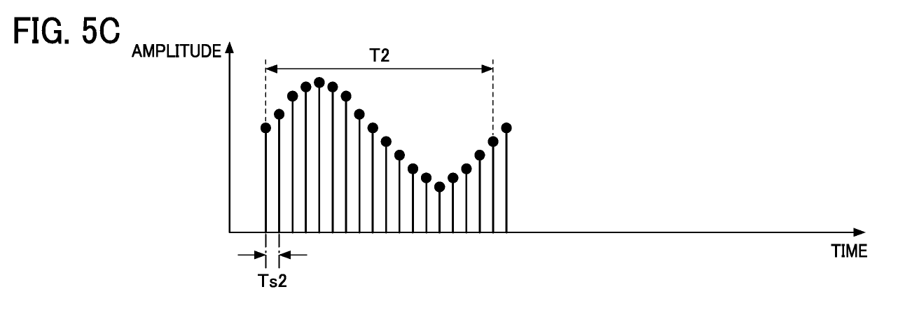

FIGS. 5A to 5C are diagrams for explaining an example of how to change a frequency, according to an embodiment of the present disclosure. Although the output apparatus 101 may change the frequencies of the frequencies f0 to f7 by the predetermined fd in any arbitrary way, a description is given hereinafter of a preferable example.

In this description, it is assumed that a basic (initial) sampling frequency is set to 48.0 kHz. FIG. 5A is a diagram illustrating a waveform of an acoustic wave generated by using the basic sampling frequency of 48.0 kHz. In the example of FIG. 5A, the waveform of the acoustic wave becomes a sine wave having amplitudes sampled with an initial sampling interval Ts0 corresponding to the basic sampling frequency of 48.0 kHz, and the acoustic wave has an initial one cycle of T0.

When to change the initial one cycle T0 to a longer cycle (i.e., to change the frequency of the acoustic wave to a lower frequency), the sampling frequency is set to a frequency, such as 47.9 kHz, lower than the basic sampling frequency 48.0 kHz. As a result, a second sampling interval Ts1 corresponding to the sampling frequency 47.9 kHz becomes longer than the initial sampling interval Ts0, and a second one cycle T1 of the acoustic wave becomes longer than the initial one cycle T0. Thus, the frequency of the acoustic wave of FIG. 5B is set with a lower value.

Similarly, when to change the initial one cycle T0 to a shorter cycle (i.e., to change the frequency of the acoustic wave to a higher frequency), the sampling frequency is set to a frequency, such as 48.1 kHz, higher than the basic sampling frequency 48.0 kHz. As a result, a second sampling interval Ts2 corresponding to the sampling frequency 48.1 kHz becomes shorter than the initial sampling interval Ts0, and one cycle T2 of the acoustic wave becomes shorter than the initial one cycle T0. Thus, the frequency of the acoustic wave of FIG. 5C is set with a higher frequency.

In this way, the output apparatus 101 changes the sampling frequency of the acoustic wave to change the frequencies of the acoustic wave that represent the acoustic wave ID to the frequencies that are lower or higher than the frequencies f0 to f7 illustrated in FIG. 3 by the predetermined frequency fd.

In another example, the output apparatus 101 may change the frequencies of the acoustic wave f0 to f7 by changing a reference clock signal, an operation clock signal, and the like supplied to an acoustic wave generator 903 that generates acoustic waves.

Hardware Configuration:

External View of Output Apparatus:

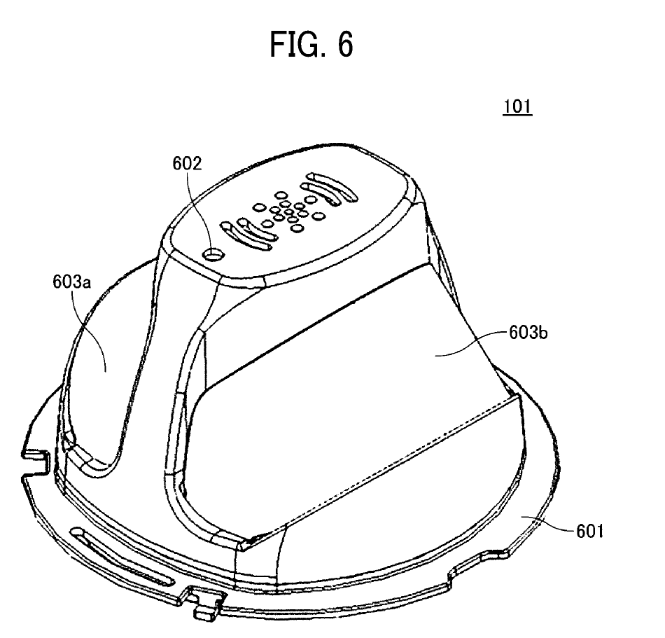

FIG. 6 is an example external view of the output apparatus 101, according to an embodiment of the present disclosure. The output apparatus 101 includes a base main unit 601. Two speakers 603a and 603b, each having a curved surface, are attached to the base main unit 601.

The speaker 603a corresponds to the first speaker described above referring to FIG. 1 and FIG. 2. The speaker 603b corresponds to the second speaker described above referring to FIG. 1 and FIG. 2.

The output apparatus 101 outputs the acoustic wave including the first acoustic wave ID using the speaker 603a, in the above-described inaudible sound range. The output apparatus 101 outputs the acoustic wave including the second acoustic wave ID using the speaker 603b, in the above-described inaudible sound range. The higher the frequency of an acoustic wave, the greater the straightness of an acoustic wave. For this reason, each of the speakers 603a and 603b of the output apparatus 101 according to the present embodiment has a curved surface in order to adjust (e.g., enlarge) an output range of acoustic wave. The speakers 603a and 603b each having a curved surface is just one example. In another example, the speakers 603a and 603b may have any other suitable shape.

The output apparatus 101 further includes, for example, a microphone 602 provided on the upper surface of the base main unit 601. The position of the microphone 602 illustrated in FIG. 6 is just one example, and the microphone 602 may be provided at any other suitable position.

Hardware Configuration of Output Apparatus:

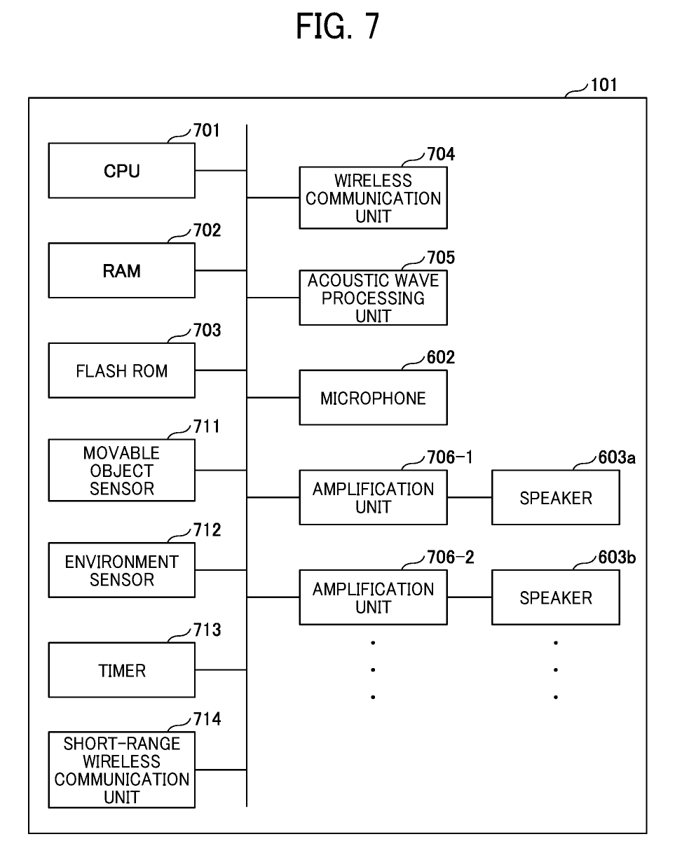

FIG. 7 is a block diagram illustrating an example of a hardware configuration of the output apparatus 101 according to an embodiment of the present disclosure. The output apparatus 101 includes, for example, a central processing unit (CPU) 701, a random access memory (RAM) 702, a flash read only memory (ROM) 703, a wireless communication unit 704, an acoustic wave processing unit 705, the microphone 602, amplification units 706-1 and 706-2, the speakers 603a and 603b, and a bus 707. In addition, the output apparatus 101 may optionally include a movable object sensor 711, an environment sensor 712, a timer 713, a short-range wireless communication unit 714.

The CPU 701 is an arithmetic unit that executes a program for the output apparatus 101 stored in the flash ROM 703, for example, to implement functions of the output apparatus 101. The RAM 702 is a volatile memory used as a work area for the CPU 701. The flash ROM 703 is a nonvolatile memory storing various information such as the program for the output apparatus 101, an output apparatus ID as an example of identification information for identifying the output apparatus 101, and the acoustic wave ID.

The wireless communication unit 704 is a wireless communication device that performs wireless communication with the gateway 103. The wireless communication unit 704 includes, for example, a transmission/reception circuit, an antenna, and a control circuit. In the present embodiment, a wireless unit of various wireless communication systems such as a wireless LAN, Zigbee (registered trademark), or specific low power wireless (IEEE 802.15.4 g) of 920 MHz band can be applied to the wireless communication unit 704.

The acoustic wave processing unit 705 performs various sound processing such as processing for generating an acoustic wave including an acoustic wave ID, under control of the CPU 701. The acoustic wave processing unit 705 is implemented by, for example, an integrated circuit for sound processing or a digital signal processor (DSP). In another example, the acoustic wave processing unit 705 is implemented by a program executed by the CPU 701 or a microcomputer, for example.

The microphone 602 includes a sound pickup element such as a microphone, and converts an acquired acoustic wave into an electric signal.

The amplification unit 706-1 is an acoustic wave amplifier that amplifies an acoustic wave signal to be output to the speaker 603a. The amplification unit 706-2 is an acoustic wave amplifier that amplifies an acoustic wave signal to be output to the speaker 603b.

The speaker 603a is a speaker that converts the acoustic wave signal output from the amplification unit 706-1 into an acoustic wave and outputs the acoustic wave. The speaker 603b is a speaker that converts the acoustic wave signal output from the amplification unit 706-2 into an acoustic wave and outputs the acoustic wave.

The bus 707 is connected to each of the above-mentioned components, and transfers address signals, data signals, and various types of control signals.

The movable object sensor 711 is, for example, a sensor (e.g., a human body sensor) for detecting a movable object such as a human body. For example, the movable object sensor 711 detects presence/absence or movement status information of a movable object such as the information terminal 104 or the user 105 in the vicinity of the output apparatus 101 indicating whether the movable object is moving or not.

The environment sensor 712 is, for example, a detection device for detecting the temperature, the wind speed, and the like around the output apparatus 101.

The timer 713 is, for example, a time measuring device that measures time to detect that it reaches a preset time.

The short-range wireless communication unit 714 is a communication device that communicates with the information terminal 104 by short-range wireless communication such as Bluetooth (registered trademark) Low Energy (BLE), for example.

Hardware Configuration of Information Terminal and Management Server:

The information terminal 104 and the management server 102 have a hardware configuration as that of a general-purpose computer. In this disclosure, a description is given of a hardware configuration of a general-purpose computer.

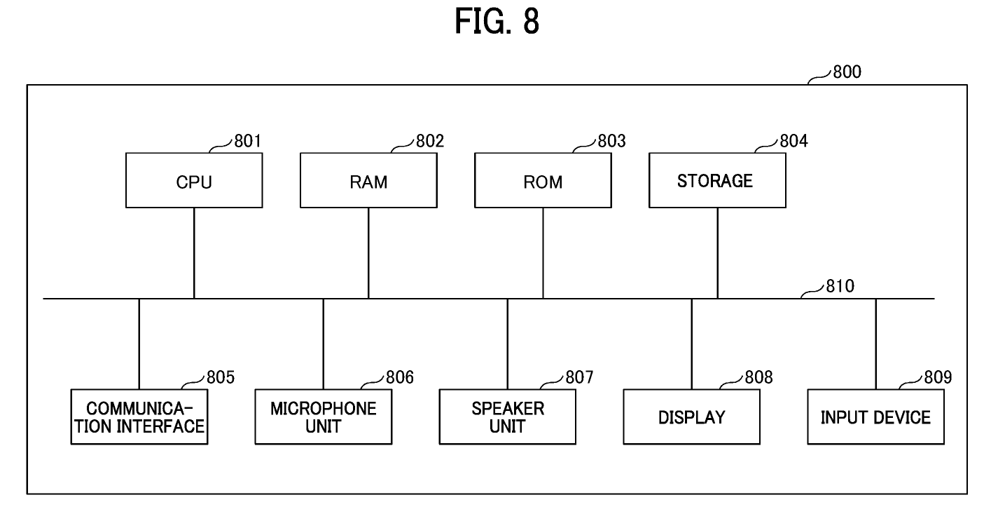

FIG. 8 is a block diagram illustrating an example hardware configuration of a computer 800 according to an embodiment of the present disclosure. The computer 800 includes, for example, a CPU 801, a RAM 802, a ROM 803, a storage 804, a communication interface 805, a microphone unit 806, a speaker unit 807, a display 808, an input device 809, and a bus 810.

The CPU 801 is an arithmetic unit that reads programs or data from the ROM 803 or the storage 804 onto the RAM 802, and executes processing according to the programs or data to implement functions of the computer 800. The RAM 802 is a volatile memory used as a work area for the CPU 801. The ROM 803 is a nonvolatile memory, which holds programs or data even after the computer 800 is turned off as the power is not supplied.

The storage 804 is, for example, a storage device such as a solid state drive (SSD) or a flash ROM storing an operating system (OS), application programs, and various types of data.

The communication interface 805 is, for example, a network interface that connects the computer 800 to the network 106.

The microphone unit 806 includes a sound pickup element such as a microphone, and converts acoustic wave acquired by the microphone into an acoustic wave signal. The microphone that the computer 800 includes can collect acoustic waves of up to 20 kHz, and more preferably up to about 24 kHz. Accordingly, the microphone unit 806 can acquire inaudible sound having a high frequency of, for example, 16 kHz or more included in the acoustic wave output from the output apparatus 101.

The speaker unit 807 includes an acoustic wave output element such as a speaker. The speaker unit 807 converts the acoustic wave signal into an acoustic wave using the speaker, for example, and outputs the acoustic wave.

The display 808 is, for example, a display device such as a liquid crystal display (LCD). The input device 809 is, for example, an input device such as a touch panel or a keyboard. The display 808 and the input device 809 may be configured as a single unit such as such as a touch panel display.

The bus 810 is connected to each of the above-mentioned components, and transfers address signals, data signals, and various types of control signals.

Functional Configuration:

Functional Configuration of Output Apparatus:

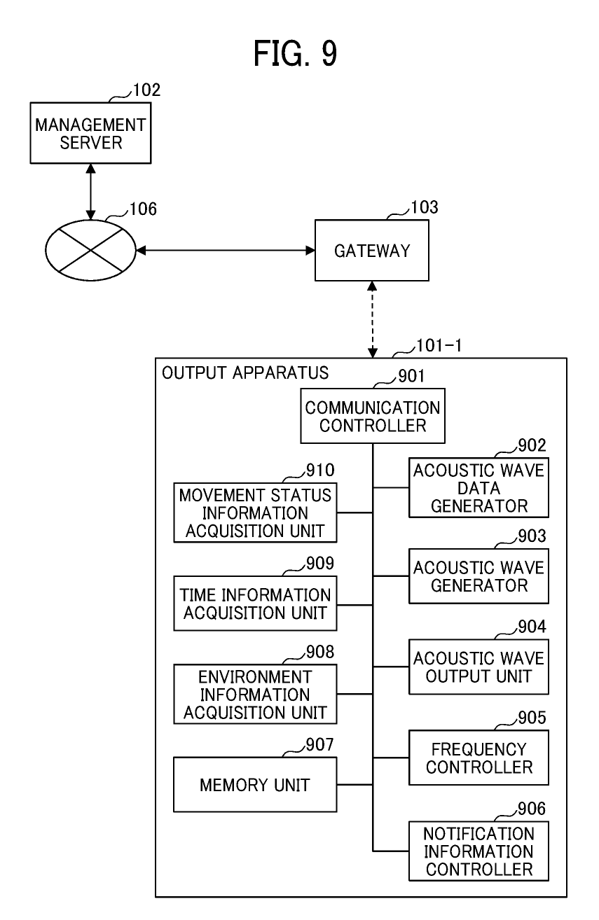

FIG. 9 is a block diagram illustrating an example of a functional configuration of the output apparatus 101 according to an embodiment of the present disclosure. The output apparatus 101 includes, for example, a communication controller 901, an acoustic wave data generator 902, an acoustic wave generator 903, an acoustic wave output unit 904, a frequency controller 905, a notification information controller 906 and a memory unit 907.

In addition, the output apparatus 101 may optionally include, for example, a movement status information acquisition unit 910, a time information acquisition unit 909, and an environment information acquisition unit 908.

The communication controller 901 is implemented by, for example, the program executed by the CPU 701 of FIG. 7 and the wireless communication unit 704. The communication controller 901 connects to a wireless network provided by the gateway 103 to communicate with the management server 102 via the gateway 103. Further, the communication controller 901 receives information such as the acoustic wave ID notified from the management server 102, and stores the received information the memory unit 907, for example.

The acoustic wave data generator 902 is implemented by, for example, the program executed by the CPU 701 of FIG. 7 and the acoustic wave processing unit 705. The acoustic wave data generator 902 generates acoustic wave data of an acoustic wave that represents an acoustic wave ID (specific identification information) using a specific frequency at a first sampling frequency. For example, the acoustic wave data generator 902 generates acoustic wave data of the acoustic wave as illustrated in FIG. 3 and FIG. 4A. The acoustic wave data generated by the acoustic wave data generator 902 is stored in, for example, the memory unit 907.

The acoustic wave generator 903 is implemented by, for example, the program executed by the CPU 701 of FIG. 7 and the acoustic wave processing unit 705. The acoustic wave generator 903 generates an acoustic wave to be output from the output apparatus 101 using the acoustic wave data generated by the acoustic wave data generator 902 at a second sampling frequency. For example, the acoustic wave data generator 902 generates an acoustic wave having frequencies different from the frequencies f0 to f7 by the predetermined frequency fd, as illustrated in FIG. 4C.

The frequency controller 905 is implemented by, for example, the program executed by the CPU 701 of FIG. 7. The frequency controller 905 changes the frequencies of the acoustic wave generated by the acoustic wave generator 903 from the frequencies f0 to f7 by the predetermined frequency fd depending on a moving direction of the information terminal 104 to be notified of the acoustic wave ID.

For example, when the moving direction of the information terminal 104 to be notified of the acoustic wave ID is a direction toward the output apparatus 101, the frequency controller 905 sets the frequencies of the acoustic wave to be generated by the acoustic wave generator 903 to be lower than the frequencies f0 to f7 by the predetermined frequency fd.

By contrast, when the moving direction of the information terminal 104 to be notified of the acoustic wave ID is a direction away from the output apparatus 101, the frequency controller 905 sets the frequencies of the acoustic wave to be generated by the acoustic wave generator 903 to be higher than the frequencies f0 to f7 by the predetermined frequency fd.

The notification information controller 906 is implemented by, for example, the program executed by the CPU 701 of FIG. 7. The notification information controller 906 changes the acoustic wave ID depending on the moving direction of the information terminal 104 to be notified of the acoustic wave ID.

The memory unit 907 is implemented by, for example, the program executed by the CPU 701 of FIG. 7, the RAM 702, and the flash ROM 703. For example, the memory unit 907 stores the acoustic wave ID notified from the management server 102, and the acoustic wave data generated by the acoustic wave data generator 902, etc.

The environment information acquisition unit 908 is implemented by, for example, the program executed by the CPU 701 and the environment sensor 712 illustrated in FIG. 7. The environment information acquisition unit 908 acquires environmental information such as air temperature and wind speed around the output apparatus 101.

The time information acquisition unit 909 is implemented by, for example, the program executed by the CPU 701 and the timer 713 illustrated in FIG. 7. The time information acquisition unit 909 acquires information such as a current time and a current time slot.

The movement status information acquisition unit 910 is implemented by, for example, the program executed by the CPU 701, the movable object sensor 711, and the short-range wireless communication unit 714 illustrated in FIG. 7. The movement status information acquisition unit 910 acquires movement status information of the information terminal 104 in the vicinity of the output apparatus 101. This movement status information includes, for example, information indicating whether any information terminal 104 is present in the vicinity of the output apparatus 101, and information indicating the movement direction of the information terminal 104 (e.g., whether the information terminal 104 is moving toward the output apparatus 101 or moving away from the output apparatus 101).

Functional Configuration of Information Providing System:

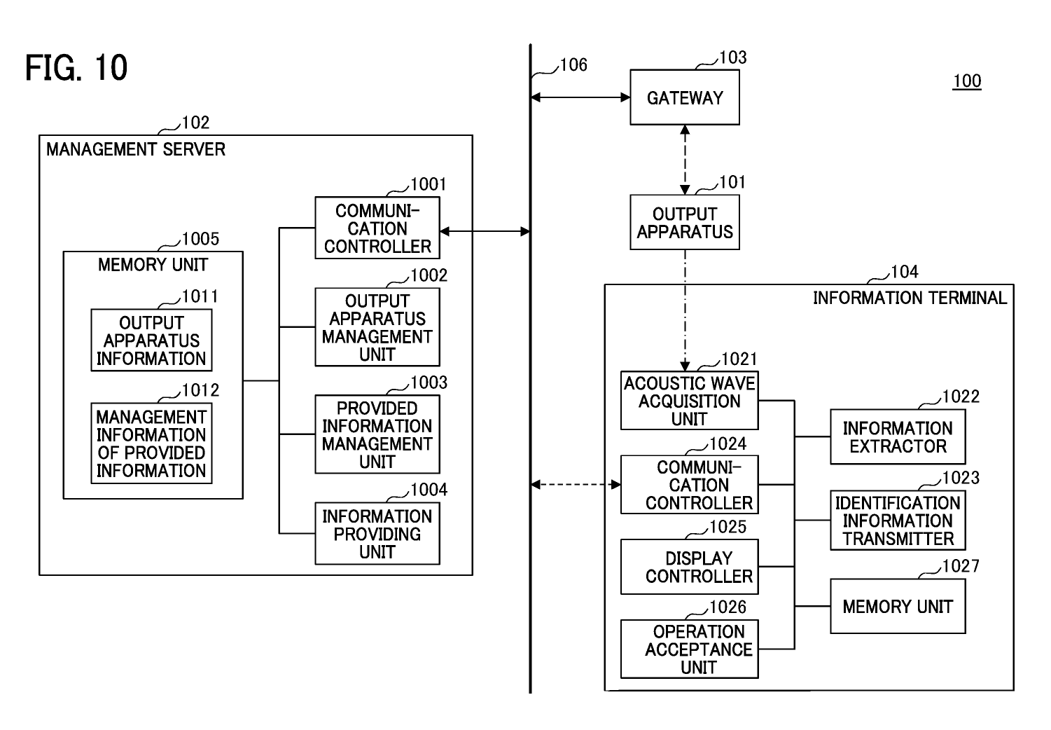

FIG. 10 is a block diagram illustrating an example of a functional configuration of the information providing system 100 according to an embodiment of the present disclosure. In FIG. 10, an example of the information providing system 100 is illustrated, including the output apparatus 101, the management server 102, the gateway 103, and the information terminal 104.

Functional Configuration of Management Server:

The management server 102 includes, for example, a communication controller 1001, an output apparatus management unit 1002, a provided information management unit 1003, an information providing unit 1004, a memory unit 1005.

The communication controller 1001 is implemented by, for example, the program executed by the CPU 801 of the management server 102 and the communication interface 805. The communication controller 1001 connects the management server 102 to the network 106 to enable the management server 102 communicate with other apparatus or device.

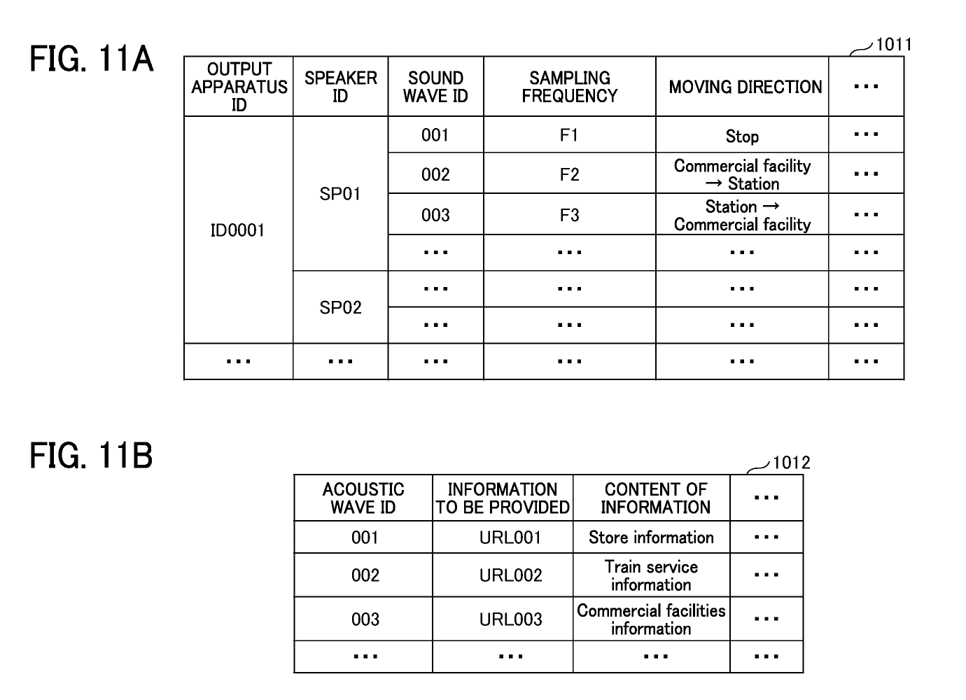

The output apparatus management unit 1002 is implemented by, for example, the program executed by the CPU 801 of the management server 102. The output apparatus management unit 1002 manages output apparatus information 1011 as illustrated in FIG. 11A stored in the memory unit 1005, for example.

FIG. 11A is an example of a table of the output apparatus information 1011. In the example of FIG. 11A, the output apparatus information 1011 includes information such as “output apparatus ID”, “speaker ID”, “acoustic wave ID”, “sampling frequency” and “moving direction”.

The “output apparatus ID” is identification information for identifying the output apparatus 101. The “speaker ID” is identification information for identifying the first speaker (speaker 603a) and the second speaker (speaker 603b) of the output apparatus 101.

The “acoustic wave ID” is identification information output from the speaker identified by the “speaker ID”. The “sampling frequency” is a sampling frequency described with reference to FIGS. 5A to 5C, which is used when the acoustic wave generator 903 of the output apparatus 101 generates an acoustic wave including the corresponding acoustic wave ID. In the example of FIG. 11A, the acoustic wave generator 903 of the output apparatus 101 uses a sampling frequency F1 (e.g., 48.0 kHz) when generating an acoustic wave including an acoustic wave ID “001”. Further, the acoustic wave generator 903 uses a sampling frequency F2 (e.g., 47.9 kHz) when generating an acoustic wave including an acoustic wave ID “002”. Furthermore, the acoustic wave generator 903 uses a sampling frequency F3 (e.g., 48.1 kHz) when generating an acoustic wave including an acoustic wave ID “003”.

The “moving direction” is information indicating a moving direction of the information terminal 104. In the example of FIG. 11A, it is assumed that a moving direction “commercial facility to station” is a direction in which the information terminal 104 moves toward the output apparatus 101. Further, it is assumed that the moving direction “station to commercial facility” is a direction in which the information terminal 104 moves away from the output apparatus 101.

The output apparatus management unit 1002 of the management server 102 transmits, to the output apparatus 101, information such as the speaker ID, the acoustic wave ID, and the sampling frequency, each included in the output apparatus information 1011, to control an acoustic wave that the output apparatus 101 is to output.

Referring again to FIG. 10, the description of the functional configuration of the management server 102 is continued.

The provided information management unit 1003 is implemented by, for example, the program executed by the CPU 801 of the management server 102. The provided information management unit 1003 manages provided information management information 1012 as illustrated in FIG. 11B stored in the memory unit 1005, for example.

FIG. 11B is an example of a table of the provided information management information 1012. In the example of FIG. 11B, the provided information management information 1012 includes information such as “acoustic wave ID”, “information to be provided”, and “content of information”.

The “acoustic wave ID” is the acoustic wave ID included in an acoustic wave output from the output apparatus 101.

The “information to be provided” is information (provided information) to be provided to the information terminal 104 that acquires each acoustic wave ID. Examples of the “provided information” include a character string to be provided to the information terminal 104, a file of the provided information, or a Uniform Resource Locator (URL) indicating a source from which the provided information can be acquired.

The “content of information” is, for example, a character string indicating the summary of the provided information.

Referring again to FIG. 10, the description of the functional configuration of the management server 102 is continued.

The information providing unit 1004 is implemented by, for example, the program executed by the CPU 801 of the management server 102. In response to receiving request information including the acoustic wave ID and the application ID of the information terminal 104 from the information terminal 104, the information providing unit 1004 refers to the provided information management information 1012 as illustrated in FIG. 11B to provide the information terminal 104 with the providing information corresponding to the acoustic wave ID.

According to the example of the output apparatus information 1011 and the provided information management information 1012 illustrated in FIGS. 11A and 11B, train service information is provided to the information terminal 104 moving in a direction from a commercial facility to a station, and store information is provided to the information terminal 104 moving in a direction from a station to a commercial facility. Further, the information terminal 104 whose moving direction is “stop” is provided with, for example, information on a store near the information terminal 104.

The memory unit 1005 is implemented by, for example, the program executed by the CPU 801 of the management server 102, the storage 804, and the RAM 802. The memory unit 1005 stores, for example, the output apparatus information 1011 and the provided information management information 1012, etc.

Functional Configuration of Information Terminal:

The information terminal 104 includes, for example, an acoustic wave acquisition unit 1021, an information extractor 1022, an identification information transmitter 1023, a communication controller 1024, a display controller 1025, an operation acceptance unit 1026, and a memory unit 1027. The information terminal 104 implements each of these functional units by executing, for example, an application for the information providing system 100 stored in the memory unit 1027.

The acoustic wave acquisition unit 1021 is implemented by, for example, the program executed by the CPU 801 of the information terminal 104 and the microphone unit 806. The acoustic wave acquisition unit 1021 acquires an acoustic wave output from the output apparatus 101.

The information extractor 1022 is implemented by, for example, the program executed by the CPU 801 of the information terminal 104. The information extractor 1022 extracts the acoustic wave ID included in the acoustic wave acquired by the acoustic wave acquisition unit 1021. For example, the information extractor 1022 analyzes the acquired acoustic waves at a predetermined sampling frequency to determine the presence or absence of signals at the frequencies f0 to f7, thereby extracting the acoustic wave ID. The predetermined sampling frequency used in this analysis is, for example, the basic sampling frequency 48.0 kHz described above referring to FIG. 5A.

The identification information transmitter 1023 is implemented by, for example, the program executed by the CPU 801 of the information terminal 104. The identification information transmitter 1023 transmits request information including the acoustic wave ID extracted by the information extractor 1022 and the application ID of the information terminal 104 to the management server 102.

The communication controller 1024 is implemented by, for example, the program executed by the CPU 801 of the information terminal 104 and the communication interface 805. The communication controller 1024 connects the information terminal 104 to the network 106 to enable the information terminal 104 to communicate with the management server 102, etc.

The display controller 1025 is implemented, for example, by the program executed by the CPU 801 of the information terminal 104. The display controller 1025 displays information such as the provided information provided from the management server 102 on the display 808 of the information terminal 104.

The operation acceptance unit 1026 is implemented by, for example, the program executed by the CPU 801 of the information terminal 104 and the input device 809. The operation acceptance unit 1026 receives an operation input by the user 105.

The memory unit 1027, which is implemented by, for example, the program executed by the CPU 801 of the information terminal 104, the storage 804, the RAM 802, stores various information.

Operation:

Hereinafter, a description is given of an operation of outputting an acoustic wave at the information providing system 100.

Overview of Operation by Output Apparatus:

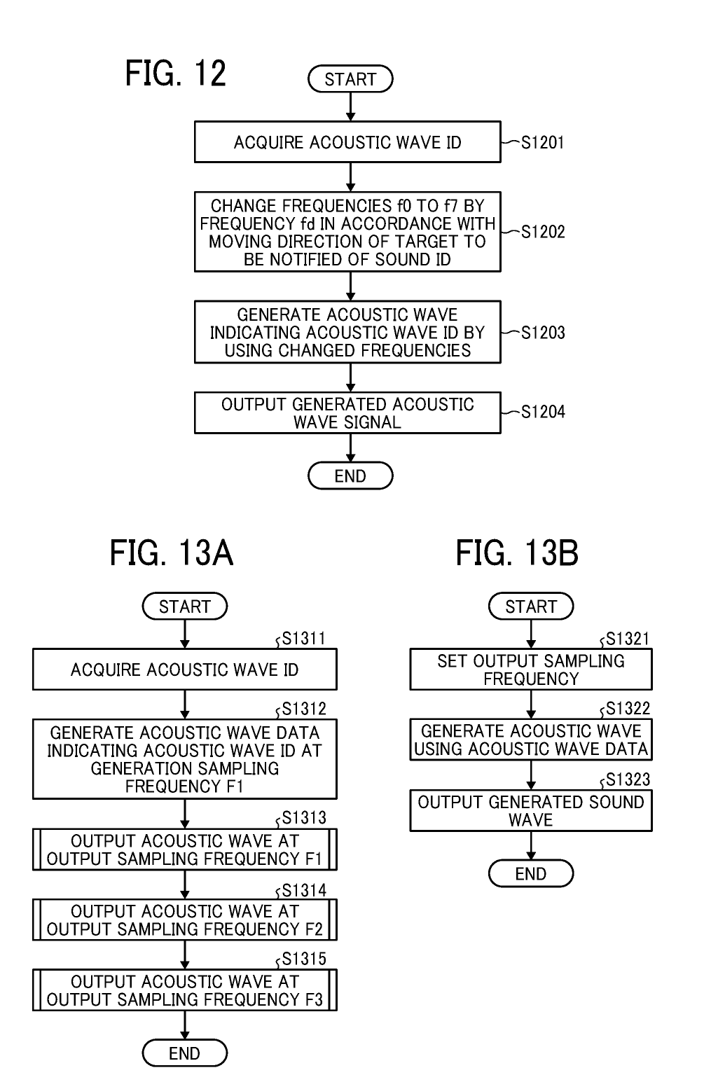

FIG. 12 is a flowchart illustrating an example of a basic operation performed by the output apparatus 101 according to an embodiment of the present disclosure.

In step S1201, the acoustic wave data generator 902 of the output apparatus 101 acquires, for example, the acoustic wave ID stored in the memory unit 907. For example, the communication controller 901 receives the acoustic wave ID transmitted from the output apparatus management unit 1002 of the management server 102, and the received acoustic wave ID is stored in advance in the memory unit 907.

In step S1202, the frequency controller 905 of the output apparatus 101 changes the frequencies representing the acoustic wave ID to frequencies that are lower or higher than the frequencies f0 to f7 such as illustrated in FIG. 3, by the predetermined frequency fd, depending on the moving direction of the information terminal 104 to be notified of the acoustic wave ID.

For example, when notifying the acoustic wave ID to the information terminal 104 moving in a direction toward the output apparatus 101, the frequency controller 905 sets frequencies to be lower than the frequencies f0 to f7 by the frequency fd. By contrast, when notifying the acoustic wave ID to the information terminal 104 moving in a direction away from the output apparatus 101, the frequency controller 905 sets frequencies to be higher than the frequencies f0 to f7 by the frequency fd.

In step S1203, the acoustic wave generator 903 of the output apparatus 101 generates an acoustic wave representing the acoustic wave ID using the frequencies (e.g., frequencies f0-fd to f7-fd) changed by the frequency controller 905. For example, when notifying the acoustic wave ID to the information terminal 104 moving in a direction toward the output apparatus 101, the acoustic wave generator 903 generates an acoustic wave as illustrated in FIG. 4C.

In step S1204, the acoustic wave output unit 904 of the output apparatus 101 outputs the acoustic wave generated by the acoustic wave generator 903 by using the speaker 603a or the speaker 603b.

In this way, the output apparatus 101 can selectively notify the acoustic wave ID to, for example, the information terminal 104 moving toward the output apparatus 101 or the information terminal 104 moving away from the output apparatus 101. Thus, only the information terminal moving toward the output apparatus 101 (or the information terminal 104 moving away from the output apparatus 101) can acquire the provided information from the management server 102 using the acoustic wave ID.

With the above-described operation, in the information providing system 100 that provides information to the information terminal 104 by using the acoustic wave output from the output apparatus 101, specific information is notified to the information terminal 104 depending on the moving direction of the information terminal 104.

Hereinafter, a description is given of several embodiments as examples of more specific operation performed by the output apparatus 101.

### First Embodiment

Operation by Output Apparatus:

FIG. 13A is a flowchart illustrating an example of operation performed by the output apparatus 101, according to the first embodiment of the present disclosure.

More specifically, FIG. 13A is a flowchart illustrating an example of operation performed by the output apparatus 101 of notifying the acoustic wave ID to the information terminal 104 moving toward the output apparatus 101, the information terminal 104 moving away from the output apparatus 101, and the information terminal 104 that is held still, by using one speaker.

In advance of the start of this operation, the output apparatus 101 acquires information such as the speaker IDs, the acoustic wave IDs, and the sampling frequencies included in the output apparatus information 1011 as illustrated in FIG. 11A and stores the acquired information in the memory unit 907.

In step S1311, the acoustic wave data generator 902 of the output apparatus 101 acquires the acoustic wave ID stored in the memory unit 907. The acoustic wave ID acquired in this step may be different acoustic wave IDs such as the acoustic wave IDs “001”, “002”, “003” depending on targets to be notified of the acoustic wave ID, as illustrated in FIG. 11A. However, in the following, a description is given assuming that the acoustic wave data generator 902 acquires one acoustic wave ID common to every target to be notified of the acoustic wave ID.

In step S1312, the acoustic wave data generator 902 of the output apparatus 101 generates acoustic wave data that represents an acoustic wave ID using the frequencies f0 to f7, at the basic sampling frequency F1 such as 48.0 kHz described above with reference to FIG. 5A.

In step S1313, the output apparatus 101 outputs an acoustic wave at an output sampling frequency F1 by an acoustic wave outputting process, which is described later with reference to FIG. 13B. The generation sampling frequency F1 at which the acoustic wave data is generated in step S1312 matches the output sampling frequency F1 at which the acoustic wave is output in step S1313. Accordingly, an acoustic wave that represents the acoustic wave ID using the frequencies f0 to f7 such as illustrated in FIG. 4A is output in the step S1313.

As a result, the output apparatus 101 can notify the acoustic wave ID acquired in step S1311 to the information terminal 104 that is not moving or the information terminal 104 moving at speed equal to or less than a specific speed.

In step S1314, the output apparatus 101 outputs an acoustic wave at an output sampling frequency F2 such as 47.9 kHz by the acoustic wave outputting process as illustrated in FIG. 13B, which is described later. The output sampling frequency F2 at which the acoustic wave is output in step S1313 is lower than the generation sampling frequency F1 at which the acoustic wave data is generated in step S1312. Accordingly, an acoustic wave that represents the acoustic wave ID using the frequencies f0-fd to f7-fd, which are lower than the frequencies f0 to f7 by the predetermined frequency fd as illustrated in FIG. 4C, is output in the step S1314.

As a result, as described above referring to FIGS. 4A to 4D, the output apparatus 101 can notify the information terminal 104 moving in a direction toward the output apparatus 101 of the acoustic wave ID acquired in step S1311.

In step S1315, the output apparatus 101 outputs an acoustic wave at an output sampling frequency F3 such as 48.1 kHz by the acoustic wave outputting process as illustrated in FIG. 13B, which is described later. The output sampling frequency F3 at which the acoustic wave is output in step S1315 is higher than the generation sampling frequency F1 at which the acoustic wave data is generated in step S1312. Accordingly, an acoustic wave that represents the acoustic wave ID using the frequencies f0+fd to f7+fd, which are higher than the frequencies f0 to f7 by the predetermined frequency fd, is output in the step S1315.

As a result, the output apparatus 101 can notify the information terminal 104 moving in a direction away from the output apparatus 101 of the acoustic wave ID acquired in step S1311.

Acoustic Wave Output Process:

FIG. 13B is a flowchart illustrating an example of an acoustic wave output process according to the first embodiment. More specifically, FIG. 13B is a flowchart illustrating an example of an operation performed by the output apparatus 101 of outputting an acoustic wave at a designated output sampling frequency.

In step S1321, the frequency controller 905 of the output apparatus 101 sets an output sampling frequency used by the acoustic wave generator 903 to generate an acoustic wave. For example, when an acoustic wave is to be output at the output sampling frequency F1 in step S1313 of FIG. 13A, the frequency controller 905 sets the output sampling frequency to F1.

Further, when an acoustic wave is to be output at the output sampling frequency F2 in step S1314 of FIG. 13A, the frequency controller 905 sets the output sampling frequency to F2. In substantially the same manner, when an acoustic wave is to be output at the output sampling frequency F3 in step S1315 of FIG. 13A, the frequency controller 905 sets the output sampling frequency to F3.

In step S1322, the acoustic wave generator 903 of the output apparatus 101 generates an acoustic wave at the output sampling frequency set in step S1321, by using the acoustic wave data generated by the acoustic wave data generator 902. Thus, the acoustic wave generator 903 can change the frequencies representing the acoustic wave ID to frequencies that are lower or higher than the frequencies f0 to f7 by the predetermined frequency fd, as described above referring to FIGS. 5A to 5C.

In step S1323, the acoustic wave output unit 904 of the output apparatus 101 outputs the acoustic wave generated by the acoustic wave generator 903 using the speaker 603a (or the speaker 603b), for example.

With the above-described operation, the output apparatus 101 can successively notify the acoustic wave ID to the information terminal 104 moving toward the output apparatus 101, the information terminal 104 moving away from the output apparatus 101, and the information terminal 104 standing still.

It should be noted that the output apparatus 101 selectively executes a part of processes of steps S1313 to S1315 in FIG. 13A, to notify the information terminal 104 that is in a specific movement status of the acoustic wave ID.

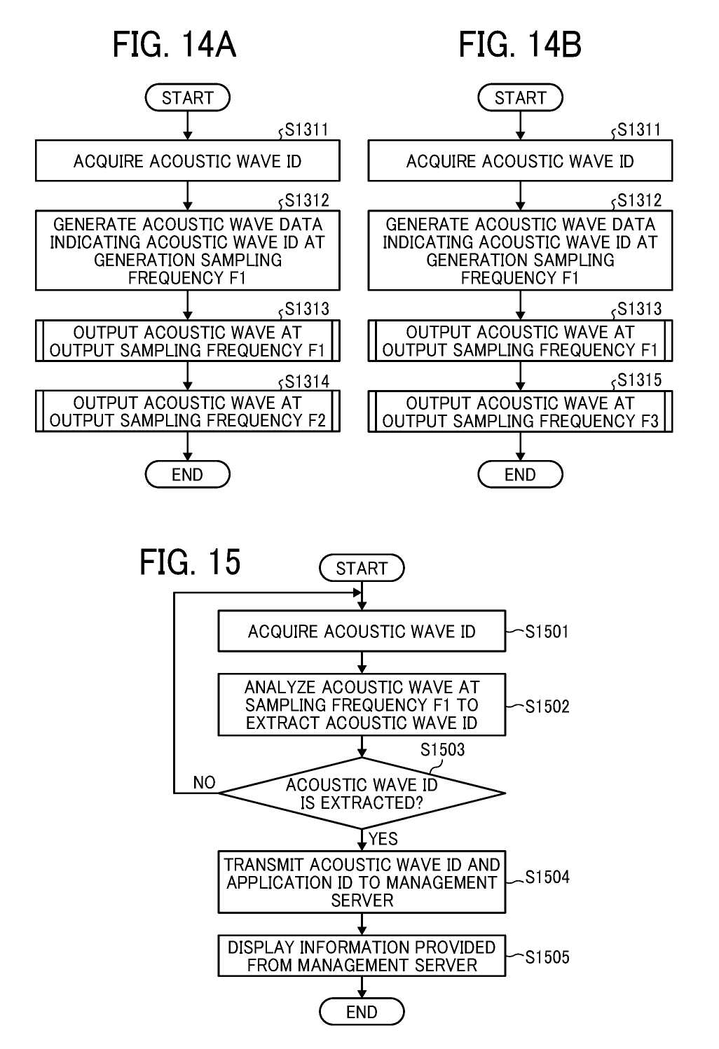

For example, FIG. 14A is a flowchart illustrating an operation in which the process of step S1315 in FIG. 13A is omitted. By executing this operation, the output apparatus 101 can notify the information terminal 104 moving toward the output apparatus 101 and the information terminal 104 standing still of the same sound ID by using one speaker, for example.

In addition, FIG. 14B is a flowchart illustrating an operation in which the process of step S1314 in FIG. 13A is omitted. By executing this operation, the output apparatus 101 can notify the information terminal 104 moving away from the output apparatus 101 and the information terminal 104 standing still of the same sound ID by using one speaker, for example.

Operation by Information Terminal:

FIG. 15 is a flowchart illustrating an example of an operation performed by the information terminal 104 according to the first embodiment. More specifically, FIG. 15 is a flowchart illustrating an operation performed by the information terminal 104 of acquiring an acoustic wave ID from an acoustic wave output from the output apparatus 101 and acquiring provided information from the management server 102 using the acquired acoustic wave ID.

In step S1501, the acoustic wave acquisition unit 1021 of the information terminal 104 acquires the acoustic wave output from the output apparatus 101.

In step S1502, the information extractor 1022 of the information terminal 104 analyzes the acoustic wave acquired by the acoustic wave acquisition unit 1021 at the basic sampling frequency F1 such as 48.0 kHz to extract an acoustic wave ID.

In step S1503, the operation branches based on determination by the information terminal 104 whether the acoustic wave ID is extracted by the information extractor 1022.

When the acoustic wave ID is not extracted by the information extractor 1022 (S1503: NO), the operation returns to step S1501, and the information terminal 104 repeats the process. By contrast, when the acoustic wave ID is extracted by the information extractor 1022 (S1503: YES), the operation proceeds to step S1504.

In step S1504, the identification information transmitter 1023 of the information terminal 104 transmits the request information including the extracted acoustic wave ID and the application ID for identifying the information terminal 104 to the management server 102 via the communication controller 1024.

In response to receiving the request information including the acoustic wave ID and the application ID from the information terminal 104, the information providing unit 1004 of the management server 102 transmits the provided information corresponding to the acoustic wave ID to the information terminal 104 from which the request information is received.

In step S1505, the display controller 1025 of the information terminal 104 controls the display 808 of the information terminal 104 to display the provided information transmitted from the management server 102.

As described heretofore, according to the present embodiment, in the information providing system 100 that provides information to the information terminal 104 by using the acoustic wave output from the output apparatus 101, the information terminal 104 is provided with specific information depending on the movement status (e.g., moving direction) of the information terminal 104.

Variation:

In the above description, the frequency controller 905 of the output apparatus 101 changes the output sampling frequency at which the acoustic wave generator 903 generates the acoustic wave, to change the specific frequencies f0 to f7 representing the acoustic wave ID by the predetermined frequency fd.

As a variation, the frequency controller 905 of the output apparatus 101 may change the generation sampling frequency used when the acoustic wave data generator 902 generates acoustic wave data, to change the frequencies representing the acoustic wave ID to frequencies that are lower or higher than the frequencies f0 to f7 by the predetermined frequency fd.

In other words, the acoustic wave data generator 902 generates a plurality pieces of acoustic wave data having different generation sampling frequencies. In this case, the acoustic wave generator 903 generates acoustic waves using different acoustic wave data at the same output sampling frequency. Accordingly, the substantially the same effect is obtained, that is, the information terminal 104 is provided with specific information depending on the movement status (e.g., moving direction) of the information terminal 104.

### Second Embodiment

With respect to the first embodiment, a description is given of an example of operation of changing the frequencies of the frequencies f0 to f7 representing the acoustic wave ID by the predetermined fd depending on the moving direction of the information terminal 104 to selectively notify the information terminal 104 moving in a specific direction of the acoustic wave ID.

In the second embodiment, a description is given of an example of operation of changing the frequencies of the frequencies f0 to f7 wave ID by predetermined fd1 and fd2 depending on the moving speed of the information terminal 104 to notify the information terminal 104 of the acoustic wave ID depending on the moving speed of the information terminal 104.

In the present embodiment, five output sampling frequencies F1 to F5 are used as an output sampling frequency to be used when the acoustic wave generator 903 generates an acoustic wave. Of these output sampling frequencies F1 to F5, F1 (e.g., 48.0 kHz), F2 (e.g., 47.9 kHz), and F3 (e.g., 48.1 kHz) are the same the output sampling frequencies used in the first embodiment.

In one example, 47.8 kHz, which is lower than the F2, is used as F4. F4 is used for notifying the acoustic wave ID to the information terminal 104 moving in a direction toward the output apparatus 101 and moving at speed faster than that assumed in the first embodiment. For example, F4 is used for notifying the acoustic wave ID to the information terminal 104 carried by a person who is running or riding a bicycle, for example, while the first embodiment is given assuming that the sound ID is to be notified to the information terminal 104 carried by a person who is walking, for example.

Further, in one example, 48.2 kHz, which is higher than F3 is used as F5. F5 is used for notifying the acoustic wave ID to the information terminal 104 moving in a direction away from the output apparatus 101 and moving at speed slower than that assumed in the first embodiment.

Operation by Output Apparatus:

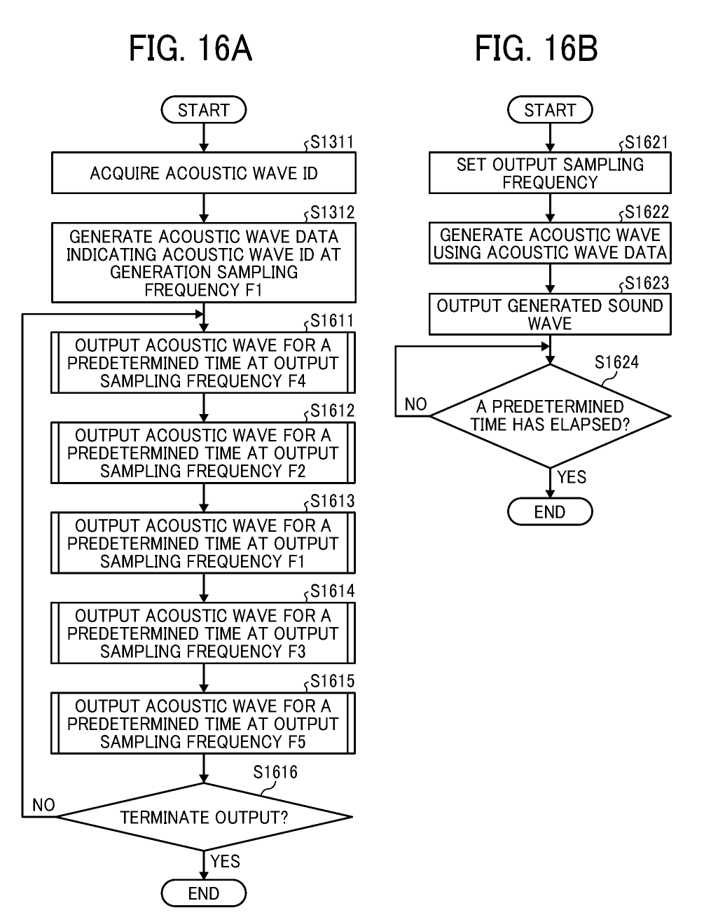

FIG. 16A is a flowchart illustrating an example of operation performed by the output apparatus 101, according to the second embodiment of the present disclosure. The processes of S1311 and S1312 in FIG. 16A are the same as those illustrated in the flowchart of FIG. 13A. Accordingly, a redundant description thereof is omitted below, and a description is given of differences between the second embodiment and the first embodiment.

In step S1611, the output apparatus 101 outputs an acoustic wave at the output sampling frequency F4 such as 47.8 kHz for a specific time such as 100 milliseconds (ins) through an acoustic wave outputting process, which is described later with reference to FIG. 16B. As a result, an acoustic wave is output that represents the acoustic wave ID using the frequencies f0-fd2 to f7-fd2, which are lower than the frequencies f0 to f7 by a predetermined frequency fd2 such as 200 Hz.

In step S1612, the output apparatus 101 outputs an acoustic wave at the output sampling frequency F2 such as 47.9 kHz for a specific time such as 100 ms through the acoustic wave outputting process, which is described later with reference to FIG. 16B. As a result, an acoustic wave is output that represents the acoustic wave ID using the frequencies f0-fd1 to f7-fd1, which are lower than the frequencies f0 to f7 by a predetermined frequency fd1 such as 100 Hz.

In step S1613, the output apparatus 101 outputs an acoustic wave at the output sampling frequency F1 such as 48.0 kHz for a specific time such as 100 ms through the acoustic wave outputting process, which is described later with reference to FIG. 16B. As a result, an acoustic wave is output that represents the acoustic wave ID using the frequencies f0 to f7.

In step S1614, the output apparatus 101 outputs an acoustic wave at the output sampling frequency F3 such as 48.1 kHz for a specific time such as 100 ms through the acoustic wave outputting process, which is described later with reference to FIG. 16B. As a result, an acoustic wave is output that represents the acoustic wave ID using the frequencies f0+fd1 to f7+fd1, which are higher than the frequencies f0 to f7 by the predetermined frequency fd1 such as 100 Hz.

In step S1615, the output apparatus 101 outputs an acoustic wave at the output sampling frequency F5 such as 48.2 kHz for a specific time such as 100 ms through the acoustic wave outputting process, which is described later with reference to FIG. 16B. As a result, an acoustic wave is output that represents the acoustic wave ID using the frequencies f0+fd2 to f7+fd2, which are higher than the frequencies f0 to f7 by the predetermined frequency fd2 such as 200 Hz.

In step S1616, the output apparatus 101 determines whether to terminate the output of acoustic wave. For example, the output apparatus 101 determines that the output of the acoustic wave is to be terminated in response to receiving an instruction for terminating the output from the management server 102.

When the output apparatus 101 determines the output of the acoustic wave is to be terminated (S1616: YES), the operation ends. By contrast, when the output apparatus 101 determines that the output of the acoustic wave is not to be terminated (S1616: NO), the operation returns to step S1611, and the output apparatus repeats the process.

With the above-described operation, the output apparatus 101 can successively transmit a plurality of acoustic waves having different output sampling frequencies to a plurality of information terminals 104 whose movement statuses are different from each other, and thereby notifying the plurality of information terminals 104 of the acoustic wave ID.

Acoustic Wave Output Process:

FIG. 16B is a flowchart illustrating an example of an acoustic wave output process according to the second embodiment. More specifically, FIG. 16B is a flowchart illustrating an example of an operation performed by the output apparatus 101 of outputting an acoustic wave at a designated output sampling frequency for a specific period of time. The processes performed in this operation are substantially the same as the acoustic wave output process according to the first embodiment described above referring to FIG. 13B, and therefore the redundant description is omitted below.

In step S1621, the frequency controller 905 of the output apparatus 101 sets an output sampling frequency used by the acoustic wave generator 903 to generate an acoustic wave. For example, when an acoustic wave is to be output at the output sampling frequency F4 in step S1611 of FIG. 16A, the frequency controller 905 sets the output sampling frequency to F4.

In step S1622, the acoustic wave generator 903 of the output apparatus 101 generates an acoustic wave at the output sampling frequency set in step S1621, by using the acoustic wave data generated by the acoustic wave data generator 902.

In step S1623, the acoustic wave output unit 904 of the output apparatus 101 outputs the acoustic wave generated by the acoustic wave generator 903 using the speaker 603a (or the speaker 603b), for example.

In step S1624, the acoustic wave output unit 904 of the output apparatus 101 determines whether a specific time such as 100 ms has elapsed since the output of the acoustic wave was started in step S1623.

When the specific time has not elapsed (S1624: NO), the acoustic wave output unit 904 continues outputting the acoustic wave. By contrast, when the specific time has elapsed (S1624: YES), the operation ends.

With the above-described operation, the output apparatus 101 can notify the acoustic wave ID to the information terminal 104 whose moving speed is faster than the moving speed assumed in the first embodiment.

It should be noted that the output apparatus 101 selectively executes a part of processes of steps S1611 to S1615 in FIG. 16A, to notify the information terminal 104 that is in a specific movement status (e.g., moving direction and moving speed) of the acoustic wave ID.

For example, when the output apparatus 101 executes only the processes of steps S1611 and S1615 out of the processes of steps S1611 to S1615 in FIG. 16A, the output apparatus 101 can selectively notify the acoustic wave ID to the information terminal 104 whose moving speed is fast.

As described heretofore, according to the present embodiment, in the information providing system 100 that provides information to the information terminal 104 by using the acoustic wave output from the output apparatus 101, the information terminal 104 is provided with specific information depending on the movement status (e.g., moving direction and moving speed) of the information terminal 104.

### Third Embodiment

In the third embodiment, a description is given of an example of operation in which the output apparatus 101 notifies different acoustic wave IDs depending on the movement status of the information terminal 104.

Operation by Output Apparatus:

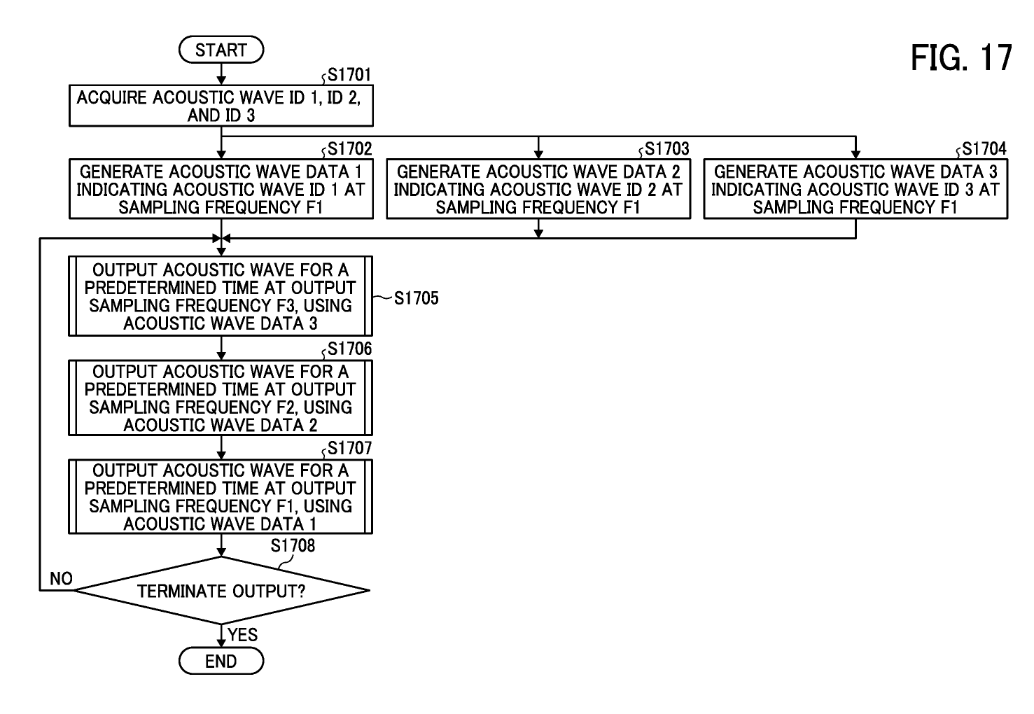

FIG. 17 is a flowchart illustrating an example of operation performed by the output apparatus 101, according to the third embodiment of the present disclosure.

More specifically, FIG. 17 is a flowchart illustrating an example of operation performed by the output apparatus 101 of notifying the different acoustic wave IDs to the information terminal 104 moving toward the output apparatus 101, the information terminal 104 moving away from the output apparatus 101, and the information terminal 104 that is held still, by using one speaker.

In advance of the start of this operation, the output apparatus 101 acquires information such as the speaker IDs, the acoustic wave IDs, and the sampling frequencies included in the output apparatus information 1011 as illustrated in FIG. 11A and stores the acquired information in the memory unit 907.

In step S1701, the notification information controller 906 of the output apparatus 101 acquires the acoustic wave IDs stored in the memory unit 907. In one example, in step S1701, the notification information controller 906 acquires three acoustic wave ID 1 “001”, the acoustic wave ID 2 “002”, and the acoustic wave ID 3 “003”, which are to be notified to different targets, as illustrated in FIG. 11A.

In step S1702, the notification information controller 906 of the output apparatus 101 controls the acoustic wave data generator 902 to generate acoustic wave data 1 representing the acoustic wave ID 1 at the basic sampling frequency F1 such as 48.0 kHz.

In step S1703, the notification information controller 906 of the output apparatus 101 controls the acoustic wave data generator 902 to generate acoustic wave data 2 representing the acoustic wave ID 2 at the basic sampling frequency F1 such as 48.0 kHz.

In step S1704, the notification information controller 906 of the output apparatus 101 controls the acoustic wave data generator 902 to generate acoustic wave data 3 representing the acoustic wave ID 3 at the basic sampling frequency F1 such as 48.0 kHz.

In step S1705, the notification information controller 906 outputs an acoustic wave by using the acoustic wave data 3 at the output sampling frequency F3 such as 48.1 kHz for a specific time such as 100 ms through the acoustic wave outputting process, which is described above with reference to FIG. 16B. By this process, the output apparatus 101 can notify, for example, the information terminal 104 moving away from the output apparatus 101 of the acoustic wave ID 3.

In step S1706, the notification information controller 906 outputs an acoustic wave by using the acoustic wave data 2 at the output sampling frequency F2 such as 47.9 kHz for a specific time such as 100 ms through the acoustic wave outputting process, which is described above with reference to FIG. 16B. By this process, the output apparatus 101 can notify, for example, the information terminal 104 moving toward the output apparatus 101 of the acoustic wave ID 2.

In step S1707, the notification information controller 906 outputs an acoustic wave by using the acoustic wave data 1 at the output sampling frequency F1 such as 48.0 kHz for a specific time such as 100 ms through the acoustic wave outputting process, which is described above with reference to FIG. 16B. By this process, the output apparatus 101 can notify, for example, the information terminal 104 standing still or the information terminal 104 moving at speed equal to or less than a specific speed of the acoustic wave ID 1.

As described above, according to the present embodiment, the output apparatus 101 can notify different sound IDs depending on the movement status (e.g., moving direction) of the information terminal 104.

### Fourth Embodiment

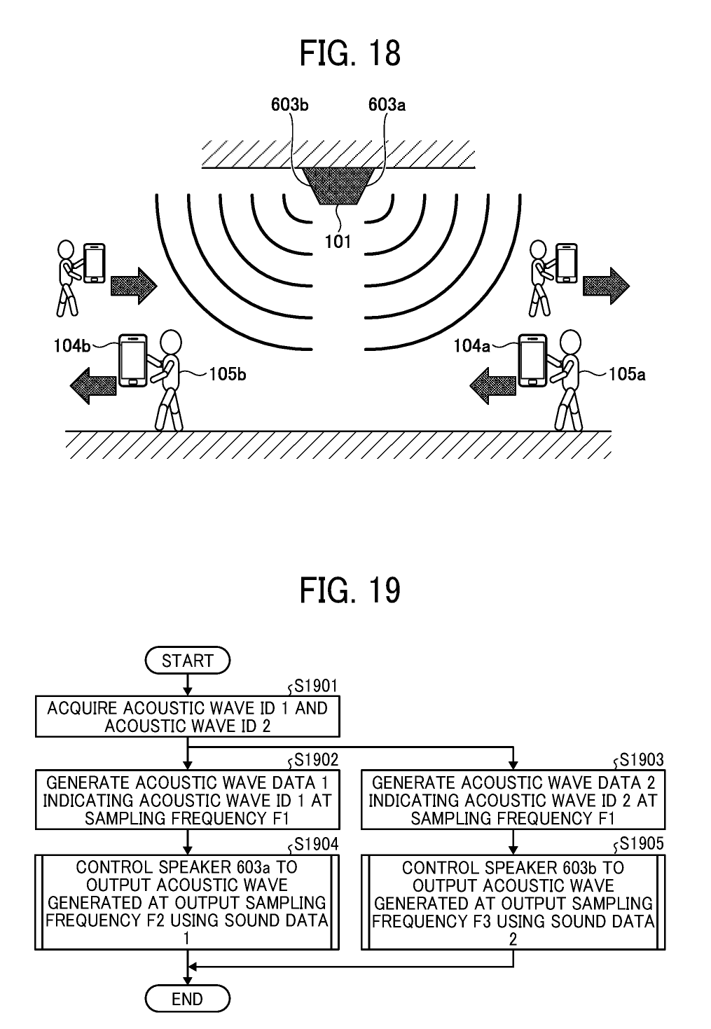

FIG. 18 is an illustration for describing a concept of an acoustic wave output process according to the fourth embodiment of the present disclosure. In the fourth embodiment, a description is given of an example in which the output apparatus 101 notifies the information terminal 104 moving in a specific direction by using two speakers.

For example, in FIG. 18, it is assumed that the output apparatus 101 outputs a first acoustic wave using the speaker 603a and a second acoustic wave using the speaker 603b. Further, it is assumed that the output apparatus 101 notifies a first acoustic wave ID to the information terminal 104 moving in a direction from the right side to the left side of FIG. 18 (hereinafter referred to as a first direction).

In this case, the output apparatus 101 outputs the first acoustic wave representing the acoustic wave ID using frequencies that are lower than the frequencies f0 to f7 by the predetermined frequency fd, using the speaker 603a. In addition, the output apparatus 101 outputs the second acoustic wave representing the acoustic wave ID using frequencies that are higher than the frequencies f0 to f7 by the predetermined frequency fd, using the speaker 603b.

As a result, an information terminal 104a carried by a user 105a who is moving toward the output apparatus 101 along the first direction can acquire the acoustic wave ID included in the first acoustic wave output from the speaker 603a.

Further, an information terminal 104b carried by a user 105b who is moving away from the output apparatus 101 along the first direction can acquire the acoustic wave ID included in the second acoustic wave output from the speaker 603b.

On the other hand, the acoustic wave ID is not notified to the information terminal 104 moving in a direction from the left side to the right side of FIG. 18 (hereinafter referred to as a second direction).

Further, in the present embodiment, the output apparatus 101 can notify the information terminal 104a moving toward the output apparatus 101 along the first direction of the acoustic wave ID 1, while notifying the information terminal 104b moving away from the output apparatus 101 along the first direction of the acoustic wave ID 2.

Thus, when the output apparatus 101 is located at a shop entrance, for example, bargain sale information is provided to a shopper heading from the inside of the store to the entrance along with a message such as “Do you have anything you forgot to buy?” Also, for example, coupon information, etc., is provided to a shopper who goes outside the store from the inside of the store along with a message such as “Thank you”.

Operation by Output Apparatus:

FIG. 19 is a flowchart illustrating an example of operation performed by the output apparatus 101, according to the fourth embodiment of the present disclosure. More specifically, FIG. 19 is a flowchart illustrating an example of operation performed by the output apparatus 101 of notifying the acoustic wave ID 1 to the information terminal 104 moving toward the output apparatus 101 along the first direction, and notifying the acoustic wave ID 2 to the information terminal 104 moving away from the output apparatus 101 along the first direction.

In step S1901, the notification information controller 906 of the output apparatus 101 acquires the acoustic wave ID 1 and acoustic wave ID 2 stored in the memory unit 907.

In step S1902, the notification information controller 906 of the output apparatus 101 controls the acoustic wave data generator 902 to generate acoustic wave data 1 representing the acoustic wave ID 1 (e.g., 001) at the basic sampling frequency F1 such as 48.0 kHz.

In step S1903, the notification information controller 906 of the output apparatus 101 controls the acoustic wave data generator 902 to generate acoustic wave data 2 representing the acoustic wave ID 2 (e.g., 002) at the basic sampling frequency F1 such as 48.0 kHz.

In step S1904, the notification information controller 906 controls the speaker 603a to output an acoustic wave generated by using the acoustic wave data 1 at the output sampling frequency F2 such as 47.9 kHz, through the acoustic wave outputting process, which is described above with reference to FIG. 16B.

In step S1905, the notification information controller 906 controls the speaker 603b to output an acoustic wave generated by using the acoustic wave data 2 at the output sampling frequency F3 such as 48.1 kHz, through the acoustic wave outputting process, which is described above with reference to FIG. 16B.

With the above-described operation, according to the present embodiment, the information providing system 100 that provides information to the information terminal 104 by using the acoustic wave output from the output apparatus 101 can provide the information terminal 104 of specific information depending on the movement status of the information terminal 104 using the plurality of speakers.

### Fifth Embodiment

In the fifth embodiment, a description is given of an example in which the output apparatus 101 detects a movement of a movable object in the vicinity of the output apparatus 101 and changes the frequencies that represents the acoustic wave data to frequencies that are lower or higher than the frequencies f0 to f7 by the predetermined frequency fd depending on a result of the detection.

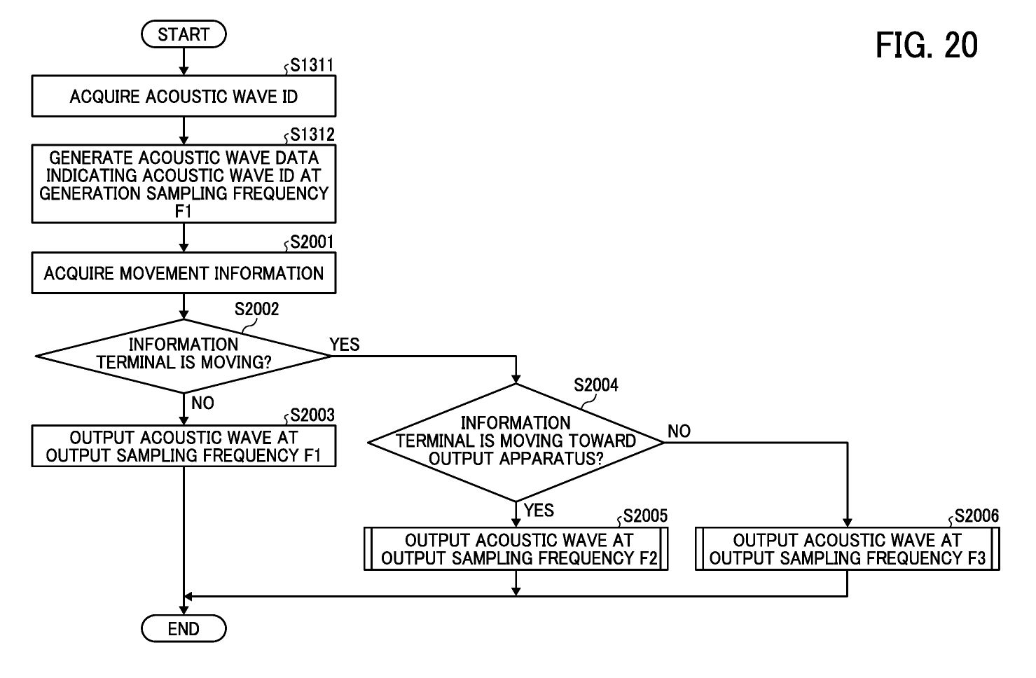

FIG. 20 is a flowchart illustrating an example of operation performed by the output apparatus 101, according to the fifth embodiment of the present disclosure. The processes of S1311 and S1312 in FIG. 20 are the same as those illustrated in the flowchart of FIG. 13A. Accordingly, a redundant description thereof is omitted below, and a description is given of differences between the fifth embodiment and the first embodiment.

In step S2001, the movement status information acquisition unit 910 of the output apparatus 101 acquires movement status information of the information terminal 104 in the vicinity of the output apparatus 101 by using the movable object sensor 711 and the short-range wireless communication unit 714. Examples of this movement status information include information indicating whether any information terminal 104 is present in the vicinity of the output apparatus 101, and information indicating the movement direction of the information terminal 104 (e.g., whether the information terminal 104 is moving toward the output apparatus 101 or moving away from the output apparatus 101).

In step S2002, the movement status information acquisition unit 910 of the output apparatus 101 determines the information terminal 104 that is present in the vicinity of the output apparatus 101 is moving.

When the information terminal 104 that is present in the vicinity of the output apparatus 101 is not moving (S2002: NO), the operation proceeds to step S2003. By contrast, when the information terminal 104 that is present in the vicinity of the output apparatus 101 is moving (S2002: YES), the operation proceeds to step S2004.

In step S2003, the output apparatus 101 outputs an acoustic wave at the output sampling frequency F1 such as 48.0 kHz by, for example, the acoustic wave output process that is described above referring to FIG. 13B.

In step S2004, the movement status information acquisition unit 910 of the output apparatus 101 determines whether the information terminal 104 is moving toward the output apparatus 101.

When the information terminal 104 is moving toward the output apparatus 101 (S2004: YES), the operation proceeds to step S2005. By contrast, when the information terminal 104 is moving away from the output apparatus 101 (S2004: NO), the operation proceeds to step S2006.

In step S2005, the output apparatus 101 outputs an acoustic wave at the output sampling frequency F2 such as 47.9 kHz by, for example, the acoustic wave output process that is described above referring to FIG. 13B. As a result, the output apparatus 101 can notify the information terminal 104 moving toward the output apparatus 101 of the acoustic wave ID.

In step S2006, the output apparatus 101 outputs an acoustic wave at the output sampling frequency F3 such as 48.1 kHz by, for example, the acoustic wave output process that is described above referring to FIG. 13B. As a result, the output apparatus 101 can notify the information terminal 104 moving away from the output apparatus 101 of the acoustic wave ID.

As described above, according to the present embodiment, the output apparatus 101 changes the frequencies representing the acoustic wave data to frequencies that are lower or higher than frequencies f0 to f7 by the predetermined frequency fd, depending on the movement status information of the movable object such as the information terminal 104 or the user 105 in the vicinity of the output apparatus 101.

### Sixth Embodiment

In the sixth embodiment, a description is given of an example of an operation according to which the acoustic wave ID is notified to the information terminal moving in different directions depending on a time slot. In the present embodiment, a plurality of time slots are set in advance. Example of the time slots include an “operation time slot” during which a facility where an event is held is available. Further, the operation time slot is categorized to two different time slots, e.g., a “first time slot” and a “second time slot”. The “first time slot” is a time slot during which peoples gather in the facility. The “second time slot” is other time period than the first time slot during the operation time slot.

Operation by Output Apparatus:

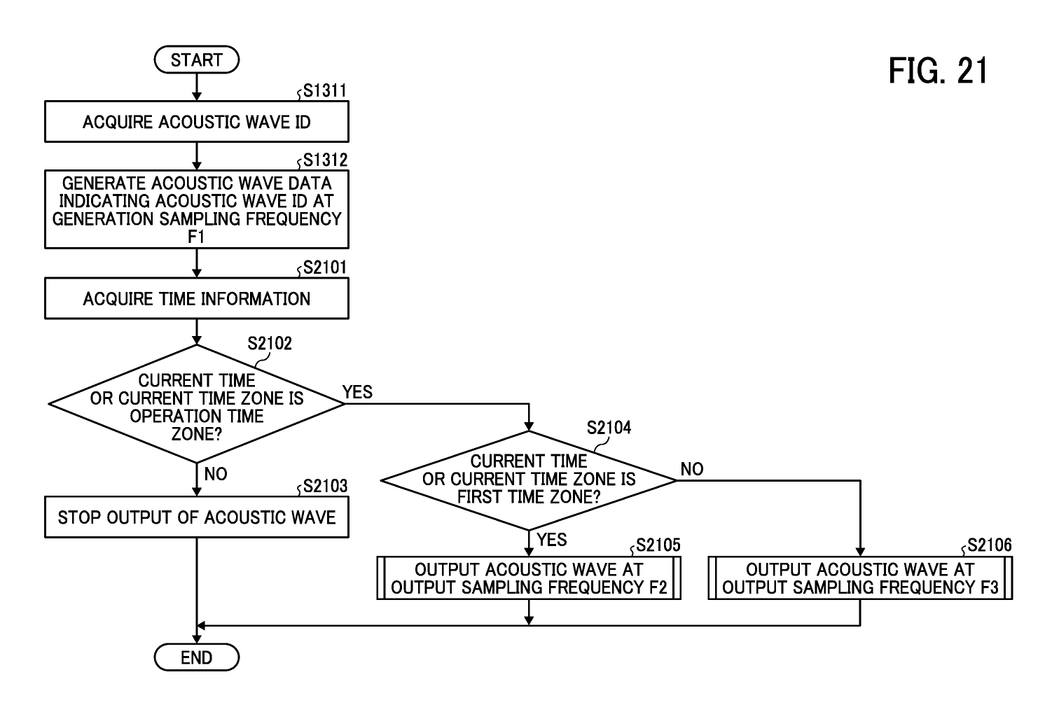

FIG. 21 is a flowchart illustrating an example of operation performed by the output apparatus 101, according to the sixth embodiment of the present disclosure. The processes of S1311 and S1312 in FIG. 21 are the same as those illustrated in the flowchart of FIG. 13A. Accordingly, a redundant description thereof is omitted below, and a description is given of differences between the sixth embodiment and the first embodiment.

In step S2101, the time information acquisition unit 909 of the output apparatus 101 acquires time information such as a current time and a current time slog using the timer 713, for example.

In step S2102, the time information acquisition unit 909 of the output apparatus 101 determines whether the current time or the current time slot is the above-described “operation time slot”.

When the current time or the current time slot is not the “operation time slot” (S2102: NO), the operation proceeds to S2103. By contrast, when the current time or the current time slot is the “operation time slot” (S2102: YES), the operation proceeds to step S2104.

In step S2103, the acoustic wave output unit 904 of the output apparatus 101 stops outputting an acoustic wave.

In step S2104, the time information acquisition unit 909 of the output apparatus 101 determines whether the current time or the time slot is the above-described “first time slot”.

When the current time or the current time slot is the “first time slot” (S2104: YES), the operation proceeds to step S2105. By contrast, when the current time or the current time slot is not the “first time slot” (S2104: NO), the operation proceeds to step S2106.

In step S2105, the output apparatus 101 outputs an acoustic wave at the output sampling frequency F2 such as 47.9 kHz by, for example, the acoustic wave output process that is described above referring to FIG. 13B. As a result, the output apparatus 101 can notify the information terminal 104 moving toward the output apparatus 101 of the acoustic wave ID.

In step S2106, the output apparatus 101 outputs an acoustic wave at the output sampling frequency F3 such as 48.1 kHz by, for example, the acoustic wave output process that is described above referring to FIG. 13B. As a result, the output apparatus 101 can notify the information terminal 104 moving away from the output apparatus 101 of the acoustic wave ID.

With the above-described operation, the output apparatus 101 can notify the information terminal 104 moving in different directions of the acoustic wave ID, depending on the time slots.

### Seventh Embodiment

In the seventh embodiment, a description is given of an example in which frequencies representing the acoustic wave ID is changed from the frequencies f0 to f7 depending on a wind velocity in the vicinity of the output apparatus 101.

When a wind velocity in the vicinity of the output apparatus 101 changes, a velocity of sound traveling through the air changes accordingly. This leads to variation in influence caused by the Doppler effect. Further, the influence of the Doppler effect varies depending on whether the information terminal 104 is on the windward side or the leeward side when viewed from the output apparatus 101.

In view of this, in the present embodiment, a description is given of an example of operation by the output apparatus 101 of detecting a wind velocity and changing the frequencies representing the acoustic wave ID from the frequencies F0 to f7 depending on the detected wind velocity.

Operation by Output Apparatus:

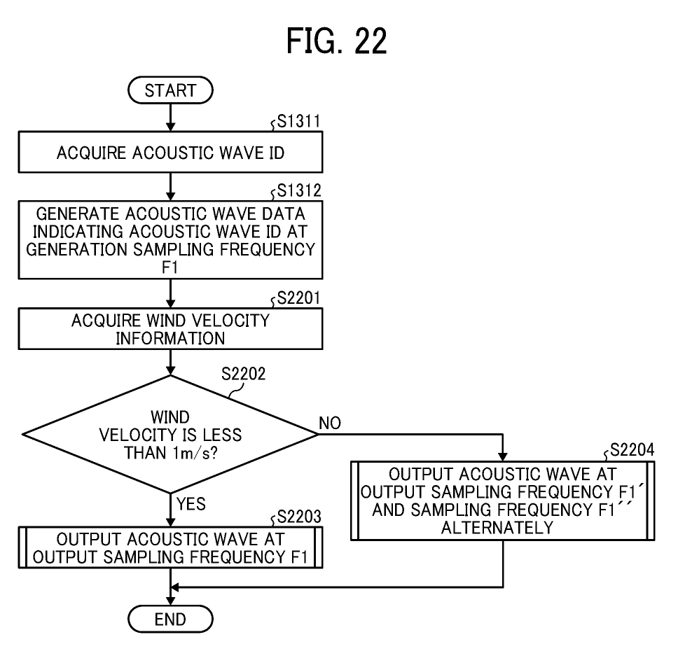

FIG. 22 is a flowchart illustrating an example of operation performed by the output apparatus 101, according to the seventh embodiment of the present disclosure. The processes of S1311 and S1312 in FIG. 22 are the same as those illustrated in the flowchart of FIG. 13A. Accordingly, a redundant description thereof is omitted below, and a description is given of differences between the seventh embodiment and the first embodiment.

In step S2201, the environment information acquisition unit 908 of the output apparatus 101 acquires information of a velocity of wind in the vicinity of the output apparatus 101, for example, using the environment sensor 712.

In step S2202, the environment information acquisition unit 908 of the output apparatus 101 determines whether the current wind velocity is less than a specific wind velocity such as 1 meter per second (m/s).

When the current wind velocity is less than the specific wind velocity (S2202: YES), the operation proceeds to step S2203. By contrast, when the current wind velocity is not less than the specific wind velocity, the operation proceeds to step S2204.

In step S2203, the output apparatus 101 outputs an acoustic wave at the output sampling frequency F1 such as 48.0 kHz by, for example, the acoustic wave output process that is described above referring to FIG. 13B.

In step S2204, the output apparatus 101 outputs acoustic waves alternately at an output sampling frequency F1′, which is lower than F1, and at an output sampling frequency F1″, which is higher than F1.

F1′, which is lower than F1, and F1″, which is higher than F1, may vary in accordance with the wind velocity. This is because the values of F2 and F3 are different depending on the wind velocity.

With the above-described operation, the frequencies representing the acoustic wave ID is changed from the frequencies f0 to f7 depending on the wind velocity in the vicinity of the output apparatus 101. This reduces influences brought by wind.

### Eighth Embodiment

In the eighth embodiment, a description is given of an example in which frequencies representing the acoustic wave ID is changed from the frequencies f0 to f7 depending on temperature in the vicinity of the output apparatus 101.

As indicated by the above Equation (1), the equation of the Doppler effect includes the sound velocity V. The sound velocity V varies depending on temperature. Accordingly, when the temperature in the vicinity of the output apparatus 101 largely changes, it is preferable to change frequencies representing the acoustic wave ID from the frequencies f0 to f7 in consideration of the variation in temperature.

In view of this, in the eighth embodiment, a description is given of an example of operation of changing frequencies representing the acoustic wave ID from the frequencies f0 to f7 depending on temperature in the vicinity of the output apparatus 101.

Operation by Output Apparatus:

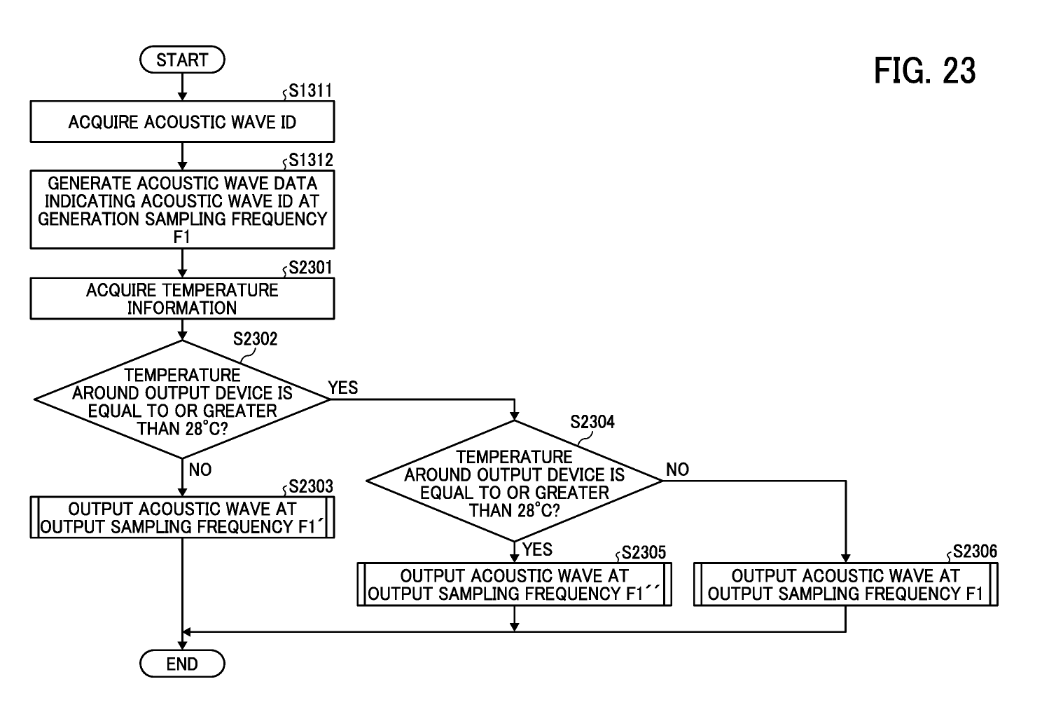

FIG. 23 is a flowchart illustrating an example of operation performed by the output apparatus 101, according to the eighth embodiment of the present disclosure. The processes of S1311 and S1312 in FIG. 23 are the same as those illustrated in the flowchart of FIG. 13A. Accordingly, a redundant description thereof is omitted below, and a description is given of differences between the eighth embodiment and the first embodiment.

In step S2301, the environment information acquisition unit 908 of the output apparatus 101 acquires information of temperature in the vicinity of the output apparatus 101, for example, using the environment sensor 712.

In step S2302, the environment information acquisition unit 908 of the output apparatus 101 determines whether the temperature in the vicinity of the output apparatus 101 is equal to or higher than 28° C.

When the temperature in the vicinity of the output apparatus 101 is equal to or higher than 28° C. (S2302: YES), the operation proceeds to step S2303. By contrast, when the temperature in the vicinity of the output apparatus 101 is not equal to or higher than 28° C. (S2302: NO), the operation proceeds to step S2304.

In step S2303, the output apparatus 101 outputs an acoustic wave at an output sampling frequency F1′, which is lower than F1, by, for example, the acoustic wave output process that is described above referring to FIG. 13B.

In step S2304, the environment information acquisition unit 908 of the output apparatus 101 determines whether the temperature in the vicinity of the output apparatus 101 is equal to or less than 18° C.

When the temperature in the vicinity of the output apparatus 101 is equal to or less than 18° C. (S2304: YES), the operation proceeds to step S2305. By contrast, when the temperature in the vicinity of the output apparatus 101 is not equal to or less than 18° C. (S2304: NO), the operation proceeds to step S2306.

In step S2305, the output apparatus 101 outputs an acoustic wave at an output sampling frequency F1″, which is higher than F1, by, for example, the acoustic wave output process that is described above referring to FIG. 13B.

In step S2306, the output apparatus 101 outputs an acoustic wave at the output sampling frequency F1 such as 48.0 kHz by, for example, the acoustic wave output process that is described above referring to FIG. 13B.

The above-described operation enables to reduce influences brought by the temperature in the vicinity of the output apparatus 101.

According to one or more embodiments of the present disclosure, in an information providing system that provides a terminal apparatus with information by using acoustic waves output from an output apparatus, it is possible to provide specific information depending on the movement status of the terminal apparatus.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. An output apparatus to output an acoustic wave set with a specific frequency indicating identification information to a terminal apparatus that is to acquire the identification information from the acoustic wave, the output apparatus comprising:
circuitry configured to:
adjust the specific frequency of the acoustic wave to another frequency by applying a predetermined frequency to the specific frequency, depending on a moving direction of a terminal apparatus that is to be notified of the identification information;
generate the acoustic wave of the another frequency; and
output the generated acoustic wave of the another frequency.

2. The output apparatus of claim 1, wherein
the circuitry sets the another frequency lower than the specific frequency by subtracting the predetermine frequency from the specific frequency, when the moving direction of the terminal apparatus to be notified of the identification information is a direction toward the output apparatus.

3. The output apparatus of claim 1, wherein
the circuitry set the another frequency higher than the specific frequency by adding the predetermined frequency to the specific frequency, when the moving direction of the terminal apparatus to be notified of the identification information is a direction away from the output apparatus.

4. The output apparatus of claim 1, wherein
the circuitry is further configured to generate acoustic wave data of the acoustic wave at a predetermined first sampling frequency,
the circuitry generates the acoustic wave using the generated acoustic wave data at a second sampling frequency, and
the circuitry changes the second sampling frequency to adjust the specific frequency of the acoustic wave to the another frequency.

5. The output apparatus of claim 1, wherein
the circuitry changes the specific frequency of the acoustic wave to the another frequency based on a moving speed of the terminal apparatus to be notified of the identification information.

6. The output apparatus of claim 1, wherein
the acoustic wave generated by the circuitry includes a plurality of acoustic waves having different frequencies each other, and
the circuitry outputs the plurality of the acoustic waves successively.

7. The output apparatus of claim 1, wherein
the circuitry is further configured to change the identification information to be notified to the terminal apparatus depending on the moving direction of the terminal apparatus.

8. The output apparatus of claim 7, wherein
the circuitry changes the identification information to be notified to the terminal apparatus depending on a moving speed of the terminal apparatus.

9. The output apparatus of claim 1, further comprising:
a first speaker to output a first acoustic wave generated by the circuitry toward a first direction; and
a second speaker to output a second acoustic wave generated by the circuitry toward a second direction, different from the first direction,
wherein the specific frequency of the first acoustic wave and the specific frequency of the second acoustic wave are different from each other.

10. The output apparatus of claim 9, wherein
The identification information represented by the first acoustic wave and the identification information represented by the second acoustic wave are different from each other.

11. The output apparatus of claim 1, wherein
the circuitry is further configured to acquire movement status information of the terminal apparatus, and
the circuitry changes the specific frequency of the acoustic wave to be generated, based on the acquired movement status information.

12. The output apparatus of claim 1, wherein
the circuitry changes the specific frequency of the acoustic wave to be generated in a preset time slot.

13. The output apparatus of claim 1, wherein
the circuitry is further configured to acquire environment information in a vicinity of the output apparatus, and
the circuitry changes the specific frequency of the acoustic wave to be generated, based on the acquired environment information.

14. A method of controlling an output of an acoustic wave set with a specific frequency indicating identification information to a terminal apparatus that is to acquire the identification information from the acoustic wave, the method comprising:
adjusting the specific frequency of the acoustic wave to another frequency by applying a predetermined frequency to the specific frequency, depending on a moving direction of a terminal apparatus that is to be notified of the identification information;
generating the acoustic wave of the another frequency; and
outputting the generated acoustic wave of the another frequency.

15. An information providing system, comprising:
an output apparatus to output an acoustic wave set with a specific frequency indicating identification information;
at least one terminal apparatus to acquire the identification information from the acoustic wave output from the output apparatus; and
an information providing apparatus to provide information corresponding to the identification information transmitted from the at least one terminal apparatus, wherein
the information providing system includes circuitry to:
adjust the specific frequency of the acoustic wave to another frequency by applying a predetermined frequency to the specific frequency, depending on a moving direction of a terminal apparatus that is to be notified of the identification information;
generate the acoustic wave of the another frequency;
output the generated acoustic wave of the another frequency; and
provide each of the at least one terminal apparatus to which the identification information is notified with information corresponding to the identification information represented by the acoustic wave output by the circuitry.
